(19) United States
(12) Patent Application Publication
(10) Pub. No.: US 2025/0150318 A1
(43) Pub. Date: May 8, 2025

(54) ELECTRONIC DEVICE AND METHOD FOR PROVIDING REMOTE INTERFERENCE MANAGEMENT-REFERENCE SIGNAL IN FRONTHAUL INTERFACE

(71) Applicant: Samsung Electronics Co., Ltd., Suwon-si (KR)

(72) Inventors: Myeongcheol SHIN, Suwon-si (KR); Seijoon SHIM, Suwon-si (KR)

(21) Appl. No.: 19/017,251

(22) Filed: Jan. 10, 2025

Related U.S. Application Data
(63) Continuation of application No. PCT/KR2023/008562, filed on Jun. 20, 2023.

(30) Foreign Application Priority Data
Jul. 11, 2022 (KR) 10-2022-0084903
Jul. 19, 2022 (KR) 10-2022-0089065

(51) Int. Cl. H04L 27/26

(52) U.S. Cl. CPC H04L 27/26134; H04L 27/2607; H04L 27/2628

(57) ABSTRACT

According to the disclosure, a method performed by a radio unit (RU) may comprise: receiving configuration information for a remote interference management (RIM)-reference signal (RS) from a distributed unit (DU); receiving a message containing bit data for the RIM-RS from the DU; generating a complex-valued symbol corresponding to the bit data for the RIM-RS; generating a RIM-RS signal by performing at least one of phase rotation or phase difference compensation for the complex-valued symbol on the basis of the configuration information; and generating a baseband signal corresponding to the RIM-RS signal based on an inverse fast fourier transform (IFFT) and cyclic prefix (CP) insertion of the RU.

### CROSS-REFERENCE TO RELATED APPLICATIONS

This application is a continuation of International Application No. PCT/KR2023/008562 designating the United States, filed on Jun. 20, 2023, in the Korean Intellectual Property Receiving Office and claiming priority to Korean Patent Application Nos. 10-2022-0084903, filed on Jul. 11, 2022, and 10-2022-0089065, filed on Jul. 19, 2022, in the Korean Intellectual Property Office, the disclosures of each of which are incorporated by reference herein in their entireties.

### BACKGROUND

### Field

The disclosure relates to a fronthaul interface. For example, the disclosure relates to an electronic device and a method for providing a remote interference management-reference signal (RIM-RS) in a fronthaul interface.

### Description of Related Art

A time duplex division (TDD) communication system supports downlink and uplink communication between a base station and a terminal using different time resources. Since a signal transmitted by a cell located far from a cell is transmitted for a long time, it may be received during an uplink period of another cell beyond a guard period. In order to measure and manage such remote interference, the base station may transmit a remote interference management (RIM)-reference signal (RS).

The above-described information may be provided as related art for the purpose of helping to understand the present disclosure. No claim or determination is raised as to whether any of the above-described information may be applied as a prior art related to the present disclosure.

### SUMMARY

According to various example embodiments, a method performed by a radio unit (RU) may comprise: receiving, from a distributed unit (DU), configuration information for remote interference management (RIM)—reference signal (RS); receiving, from the DU, a message including bit data for the RIM-RS; generating a complex-valued symbol corresponding to the bit data for the RIM-RS; generating a RIM-RS signal by performing at least one of a phase rotation or a phase difference compensation for the complex-valued symbol based on the configuration information; and generating a baseband signal corresponding to the RIM-RS signal based on an inverse fast fourier transform (IFFT) and cyclic prefix (CP) insertion of the RU.

According to various example embodiments, an electronic device of a radio unit (RU) may comprise: a fronthaul transceiver, at least one radio frequency (RF) transceiver, and at least one processor, comprising processing circuitry, coupled to the fronthaul transceiver and the at least one RF transceiver, wherein at least one processor, individually and/or collectively, may be configured to: receive, from a distributed unit (DU) through the fronthaul transceiver, configuration information for remote interference management (RIM)—reference signal (RS); receive, from the DU through the fronthaul transceiver, a message including bit data for the RIM-RS; generate a complex-valued symbol corresponding to the bit data for the RIM-RS; generate a RIM-RS signal by performing at least one of a phase rotation or a phase difference compensation for the complex-valued symbol based on the configuration information; and generate a baseband signal corresponding to the RIM-RS signal based on an inverse fast fourier transform (IFFT) and cyclic prefix (CP) insertion of the RU.

According to various example embodiments, a method performed by a distributed unit (DU) may comprise: transmitting, to a radio unit (RU), configuration information for remote interference management (RIM)—reference signal (RS); transmitting, to the RU, a message including bit data for the RIM-RS, wherein the configuration information may be used for at least one of a phase rotation or a phase difference compensation for a complex-valued symbol to generate a baseband signal through inverse fast fourier transform (IFFT) and cyclic prefix (CP) insertion of the RU, and the complex-valued symbol may correspond to a modulation result of the bit data for the RIM-RS.

According to various example embodiments, an electronic device of a distributed unit (DU) may comprise: at least one transceiver including a fronthaul transceiver, and at least one processor, comprising processing circuitry, coupled to the at least one transceiver, wherein at least one processor, individually and/or collectively, may be configured to control the DU to: transmit, to a radio unit (RU) through the fronthaul transceiver, configuration information for remote interference management (RIM)—reference signal (RS); transmit, to the RU through the fronthaul transceiver, a message including bit data for the RIM-RS, wherein the configuration information may be used for at least one of a phase rotation or a phase difference compensation for a complex-valued symbol to generate a baseband signal through inverse fast fourier transform (IFFT) and cyclic prefix (CP) insertion of the RU, and the complex-valued symbol may correspond to a modulation result of the bit data for the RIM-RS.

According to various example embodiments, a non-transitory computer-readable storage medium is provided. The non-transitory computer-readable storage medium may store one or more programs. The one or more programs may comprise instructions which, when executed by at least one processor of a radio unit (RU), individually and/or collectively, cause the RU to: receive, from a distributed unit (DU), configuration information for remote interference management (RIM)—reference signal (RS); receive, from the DU, a message including bit data for the RIM-RS; generate a complex-valued symbol corresponding to the bit data for the RIM-RS; generate a RIM-RS signal by performing at least one of a phase rotation or a phase difference compensation for the complex-valued symbol based on the configuration information; and generate a baseband signal corresponding to the RIM-RS signal based on an inverse fast fourier transform (IFFT) and cyclic prefix (CP) insertion of the RU.

According to various example embodiments, a non-transitory computer-readable storage medium is provided. The non-transitory computer-readable storage medium may store one or more programs. The one or more programs may comprise instructions which, when executed by at least one processor of a distributed unit (DU), individually and/or collectively, cause the DU to: transmit, to a radio unit (RU), configuration information for remote interference management (RIM)—reference signal (RS); transmit, to the RU, a message including bit data for the RIM-RS, wherein the configuration information may be used for at least one of a phase rotation or a phase difference compensation for a complex-valued symbol to generate a baseband signal through inverse fast fourier transform (IFFT) and cyclic prefix (CP) insertion of the RU, and the complex-valued symbol may correspond to a modulation result of the bit data for the RIM-RS.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of remote interference, according to various embodiments;

FIGS. 2A, 2B, and 2C are diagrams illustrating examples of remote interference management according to various embodiments;

FIG. 3A is a block diagram illustrating an example fronthaul interface according to various embodiments;

FIG. 3B is a diagram illustrating an example fronthaul interface of an open (O)-radio access network (RAN) according to various embodiments;

FIG. 4A is a block diagram illustrating an example configuration of a distributed unit (DU) according to various embodiments;

FIG. 4B is a block diagram illustrating an example configuration of a radio unit (RU) according to various embodiments;

FIG. 5 is a diagram illustrating an example of remote interference management (RIM)-reference signal (RS) structure according to various embodiments;

FIG. 6 is a diagram illustrating a functional configuration per network entity for compressed bit data transmission according to various embodiments;

FIG. 7 is a diagram illustrating an example of a cyclic shift according to various embodiments;

FIG. 8 is a diagram illustrating an example configuration per network entity for downlink transmission according to various embodiments;

FIG. 9A is a diagram illustrating an example of a cyclic shifter according to various embodiments;

FIG. 9B is a diagram illustrating an example of a phase difference compensator according to various embodiments;

FIG. 10 is a block diagram illustrating an example configuration per network entity for RIM-RS transmission according to various embodiments;

FIG. 11 is a diagram illustrating an example of RIM-RS mapping according to various embodiments;

FIG. 12 is a flowchart illustrating example operations of an RU for RIM-RS transmission according to various embodiments;

FIG. 13 is a flowchart illustrating example operations of an RU for complex mapping of RIM-RS according to various embodiments;

FIG. 14 is a flowchart illustrating example operations of an RU for phase rotation of RIM-RS according to various embodiments;

FIG. 15 is a flowchart illustrating example operations of an RU for phase difference compensation of RIM-RS according to various embodiments; and

FIG. 16 is a flowchart illustrating example operations of a DU for RIM-RS transmission according to various embodiments.

### DETAILED DESCRIPTION

Terms used in the present disclosure are used simply to describe various example embodiments, and may not be intended to limit the scope of the disclosure. A singular expression may include a plural expression unless the context clearly indicates otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

Terms referring to information (e.g., configuration information, additional information, control information), terms referring to operation state (e.g., step, operation, procedure), terms referring to data (e.g., information, value, command), terms referring to signal (e.g., packet, message, signal, information, signaling), terms referring to resource (e.g., section, symbol, slot, subframe, radio frame, subcarrier, resource element (RE), resource block (RB), bandwidth part (BWP), occasion), terms referring to operation state (e.g., step, operation, procedure), terms referring to data (e.g., packet, message, user stream, information, bit, symbol, codeword), terms referring to channel, terms referring to network entity (e.g., distributed unit (DU), radio unit (RU), central unit (CU), CU-control plane(CP), CU-user plane(UP), open radio access network (O-RAN) DU (O-DU), O-RAN RU (O-RU), O-RAN CU (O-CU), O-RAN CU-CP (O-CU-UP), O-RAN CU-CP (O-CU-CP)), and terms referring to components of a device, used in the following description are used for convenience of explanation. Therefore, the present disclosure is not limited to terms to be described below, and another term having an equivalent technical meaning may be used. In addition, a term such as ‘ . . . unit, ‘ . . . device, ‘ . . . material’, and ‘ . . . structure’, and the like used below may refer, for example, to at least one shape structure or may refer, for example, to a unit processing a function.

In addition, in the present disclosure, the term ‘greater than’ or ‘less than’ may be used to determine whether a particular condition is satisfied or fulfilled, but this is merely a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ refer to including at least one of ‘C’ or ‘D’, that is, {‘C.’, ‘D’, and ‘C’ and ‘D’}.

Although the present disclosure describes various embodiments using terms used in various communication standards (e.g., 3rd Generation Partnership Project (3GPP), extensible radio access network (xRAN), open-radio access network (O-RAN)), these are merely examples for explanation. The various example embodiments of the present disclosure may be easily modified and applied to other communication systems.

The present disclosure provides an electronic device and a method for providing a remote interference management (RIM)-reference signal (RS) on a fronthaul interface. In addition, the present disclosure provides an electronic device and a method for transmitting configuration information for RIM-RS to provide the RIM-RS through a lossless compression technique on the fronthaul interface. In addition, the present disclosure provides an electronic device and a method for performing complex mapping of modulation for the RIM-RS in a radio unit (RU) by transmitting configuration information for the RIM-RS to the RU on the fronthaul interface.

An electronic device and a method according to embodiments of the present disclosure may reduce the bandwidth of a fronthaul interface by providing RIM-RS through a lossless compression technique on a fronthaul interface.

An electronic device and a method according to embodiments of the present disclosure may transmit remote interference management (RIM)-reference signal (RIM-RS) based on existing hardware configurations through cyclic shift and phase difference compensation for the RIM-RS.

The effects that can be obtained from the present disclosure are not limited to those described above, and any other effects not mentioned herein may be clearly understood by those of ordinary skill in the art to which the present disclosure belongs, from the following description.

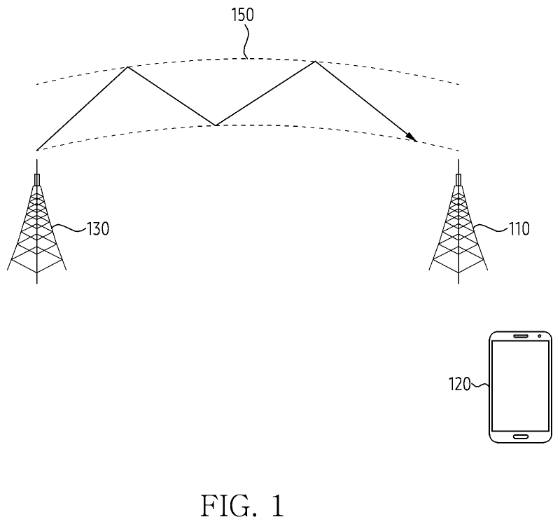

FIG. 1 is a diagram illustrating an example of remote interference, according to various embodiments.

Referring to FIG. 1, FIG. 1 illustrates a base station 110, a base station 130 and a terminal 120 as a portion of nodes that utilize a wireless channel in a wireless communication system. FIG. 1 illustrates two base stations, but a wireless communication system may further include another base station that is identical or similar to the base station 110.

The base station 110 is a network infrastructure that provides wireless access to the terminal 120. The base station 110 has coverage defined based on a distance at which a signal can be transmitted. The base station 110 may be referred to as an ‘access point (AP)’, ‘eNodeB (eNB)’, ‘5th generation node’, ‘next generation nodeB (gNB)’, ‘wireless point’, ‘transmission/reception point (TRP)’ or other terms having equivalent technical meanings, in addition to the base station.

The terminal 120, which may refer to a device used by a user, performs communication with the base station 110 through a wireless channel. A link from the base station 110 to the terminal 120 is referred to as a downlink (DL), and a link from the terminal 120 to the base station 110 is referred to as an uplink (UL). In addition, although not illustrated in FIG. 1, the terminal 120 and another terminal may perform communication through a wireless channel. At this time, a link between the terminal 120 and another terminal (device-to-device link (D2D)) is referred to as a sidelink, and the sidelink may be used interchangeably with a PC5 interface. In various embodiments, the terminal 120 may be operated without the user's involvement. According to an embodiment, the terminal 120, which is a device that performs machine type communication (MTC), may not be carried by the user. Additionally, according to an embodiment, the terminal 120 may be a narrowband (NB)-internet of things (IoT) device.

In addition to the term terminal, the terminal 120 may also be referred to as user equipment (UE), customer premises equipment, (CPE), mobile station, subscriber station, remote terminal, wireless terminal, electronic device, user device, or other terms having equivalent technical meanings.

In a time duplex division (TDD) communication technique, a frequency domain in which the uplink channel and the downlink channel are the same may be used. At this time, downlink communication and uplink communication use different time resources because interference between channels occurs if downlink communication and uplink communication overlap in a time domain. A combination of time resources for TDD communication may be referred to as a TDD pattern. A downlink period of the TDD pattern may be set. The downlink period may be set based on at least one of one or more slots or one or more symbols. The downlink period may be set based on one or more slots. The downlink period may be set based on one or more symbols. The downlink period may be set based on one or more slots and one or more symbols. In addition, an uplink period of the TDD pattern may be set. The uplink period may be set based on at least one of one or more slots or one or more symbols. The uplink period may be set based on one or more slots. The uplink period may be set based on one or more symbols. The uplink period may be set based on one or more slots and one or more symbols.

In the TDD communication system, a flexible period of the TDD pattern may be operated for switching between the downlink period and the uplink period. The flexible period may also be referred to as a guard period. In general, the flexible period is set considering a propagation speed of a wireless signal and a typical path loss, but a propagation range of a wireless signal may increase under certain climatic conditions. For example, since a downlink signal 150 transmitted on a cell of a base station 130 located far from a base station 110 is transmitted for a long time, it may be received during an uplink period of another cell, beyond the guard period. At this time, the downlink signal 150 may act as interference to the uplink transmission of the terminal 120 on the cell of the base station 110. Here, the base station 130 from which the downlink signal (150) is transmitted may be referred to as an aggressor node. The cell of the base station (130) may be referred to as an aggressor cell. The base station (110) may be referred to as a victim node. The cell of the base station (110) may be referred to as a victim cell. The interference may be referred to as remote interference, time-of-flight (TOF) interference, long-distance cell interference, propagation delay interference, or self-interference. In the TDD communication system, the quality of uplink communication may be deteriorated by such remote interference.

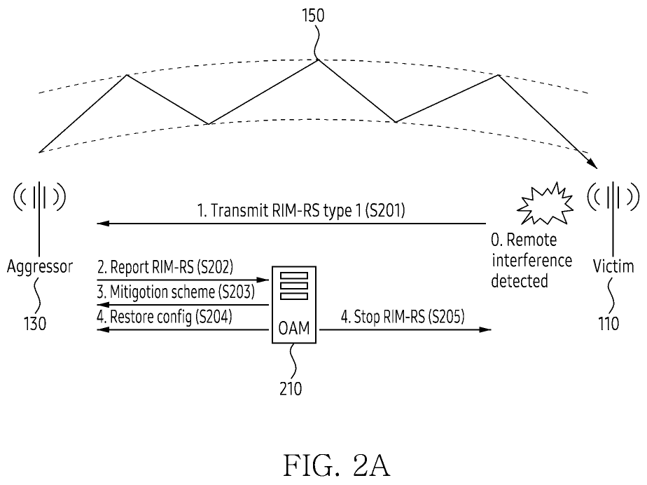

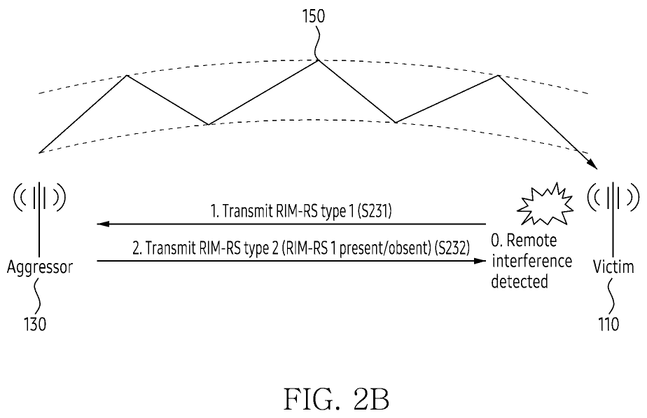

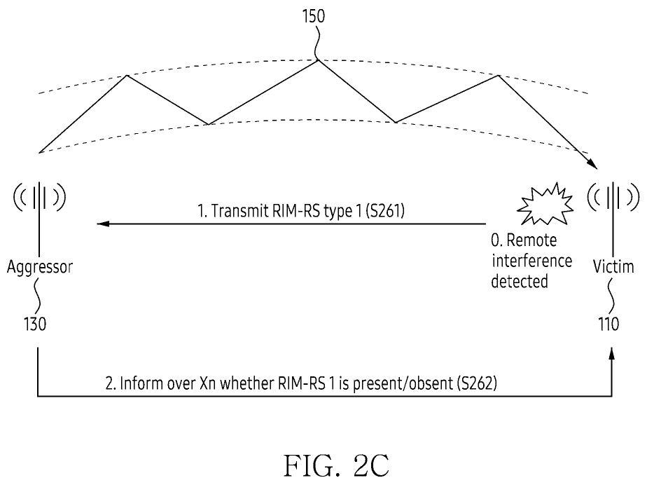

In case that the downlink signal 150 of the other base station 130 flows into the uplink transmission period of the base station 110, an uplink signal transmitted at a relatively low output may be vulnerable to interference (e.g., remote interference) due to the downlink signal 150. Therefore, a method for measuring the remote interference and controlling the remote interference is required. In the 5G NR system, a remote interference management-reference signal (RIM-RS) has been introduced to detect the above-described remote interference and control the interference. Hereinafter, examples of remote interference detection and interference control based on RIM-RS are described in greater detail with reference to FIGS. 2A, 2B and 2C (which may be referred to as FIGS. 2A to 2C).

FIGS. 2A, 2B, and 2C are diagrams illustrating examples of remote interference management according to various embodiments. Through FIGS. 2A to 2C, frameworks for remote interference handling are described. A difference between the frameworks is a location of a decision to apply interference mitigation in the network, and a way of delivering the decision between nodes. Hereinafter, three frameworks are illustrated, but other framework variations may be easily considered, and artificial intelligence and machine learning may be used for the framework.

Referring to FIG. 2A, an operation and management (OAM) device 210 may perform all decisions related to remote interference mitigation in a centralized remote interference management framework. If remote interference is detected, the base station 110, which is a victim node, may transmit a first type of RIM-RS (S201). The first type corresponds to RIM-RS type 1 of 3GPP. The first type of RIM-RS may not only indicate that a cell is experiencing remote interference, but may also include information on the ID of a node (or group of nodes) transmitting a reference signal and the number of orthogonal frequency division multiplexing (OFDM) symbols in the affected uplink period. The information may be implicitly encoded in the RIM-RS. Since the atmosphere duct is reciprocal, the base station 130 providing an aggressor cell contributing to the remote interference of the victim may receive the RIM-RS.

Upon receiving the RIM-RS, the base station 130, which is an aggressor node, may report the detected RIM-RS to the OAM device 210 (S202). For further determination on how to resolve the interference problem, the base station 130 may transmit the detected RIM-RS, which includes information encoded in the RIM-RS, to the OAM device 210. The OAM device 210 may transmit a command indicating a change in the TDD pattern to the base station 130 (S203). The OAM device 210 may take a decision on a suitable mitigation scheme, which requests the aggressor cell to stop downlink transmission earlier in order to extend the guard period. Thereafter, if the ducting phenomenon disappears, the base station 130 no longer detects the RIM-RS. The base station 130 may transmit a report on interference elimination to the OAM device 210. The OAM device 210 may command the base station 110 to stop the RIM-RS transmission (S205). In addition, the OAM device 210 may request the base station 130 to restore the previous configuration of the TDD pattern (S204). The operation S204 may be performed independently of the operation S205.

Referring to FIG. 2B, if remote interference is detected, the base station 110, which is a victim node, may transmit a first type RIM-RS (S231). When the base station 130, which is an aggressor node, receives the first type RIM-RS, the base station 130 may identify that the base station 110 is experiencing remote interference. The base station 130 may transmit a second type RIM-RS to the base station 110 (S232). The second type corresponds to RIM-RS type 2 of 3GPP. The base station 130 may transmit, to the base station 110, a radio signal to notify that it has received the first type RIM-RS and applied a suitable mitigation plan. The base station 110 receiving the second type of RIM-RS may detect whether remote interference exists. If the base station 110 does not detect the second type of RIM-RS, the base station 110 may identify the disappearance of remote interference. The base station 110 may stop transmitting the first type of RIM-RS. Thereafter, the base station 130, which is an aggressor node, may restore the pattern configuration before interference detection, based on identifying that the first type of RIM-RS is no longer received.

Referring to FIG. 2C, if remote interference is detected, the base station 110, which is a victim node, may transmit the first type RIM-RS (S261). When the base station 130, which is an aggressor node, receives the first type RIM-RS, the base station 130 may identify that the base station 110 is experiencing remote interference. The base station 130 may transmit a backhaul signal to the base station 110 through an Xn interface (S262). The backhaul signal through the Xn interface may be used to inform the base station 110 of the presence or absence of the first type RIM-RS from the base station 130. The backhaul signal indicating the absence of the first type RIM-RS may be used to determine that remote interference no longer exists and to stop transmission of the first type RIM-RS. The base station 130, which is an aggressor node, may restore the pattern configuration before interference detection, based on identifying that the first type RIM-RS is no longer received.

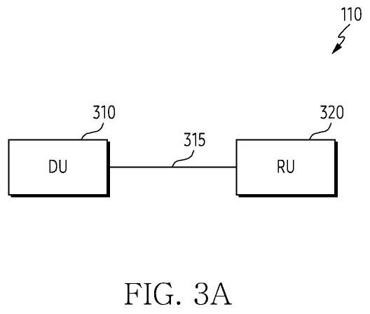

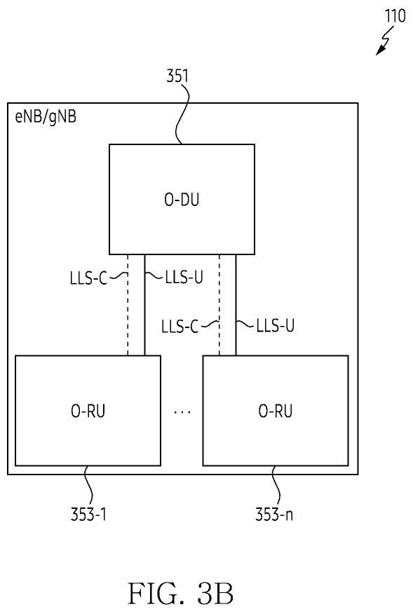

In the past, in communication systems with relatively large cell radius of base stations, each base station was installed to include functions of a digital processing unit (or distributed unit (DU)) and a radio frequency (RF) processing unit (or radio unit (RU)). However, as high frequency bands are used in 4th generation (4G) and/or subsequent communication systems (e.g., 5G) and the cell coverage of base stations becomes smaller, the number of base stations to cover a specific area has increased. The installation cost burden of operators for installing base stations has also increased. In order to minimize and/or reduce the installation cost of a base station, a structure has been proposed in which the DU and RU of the base station are separated, one or more RUs are connected to one DU through a wired network, and one or more RUs are geographically distributed to cover a specific area. Hereinafter, a deployment structure and expansion examples of a base station according to various embodiments of the present disclosure are described through FIGS. 3A and 3B.

FIG. 3A is a block diagram illustrating an example configuration of a fronthaul interface according to various embodiments. The fronthaul refers to an interface between entities between a radio access network and a base station, unlike backhaul between a base station and a core network. In FIG. 3A, an example of a fronthaul structure between one DU 310 and one RU 320 is illustrated, but this is simply for convenience of explanation and the present disclosure is not limited thereto. In other words, the various embodiments of the present disclosure may also be applied to a fronthaul structure between one DU and a plurality of RU. For example, various embodiments of the present disclosure may be applied to a fronthaul structure between one DU and two RU. In addition, various embodiments of the present disclosure may also be applied to a fronthaul structure between one DU and three RU.

Referring to FIG. 3A, the base station 110 may include a DU 310 and a RU 320. A fronthaul 315 between the DU 310 and the RU 320 may be operated via an Fx interface. For example, for operating the fronthaul 315, an interface such as an enhanced common public radio interface (eCPRI) or radio over ethernet (ROE) may be used.

As communication technology has been developed, mobile data traffic increases, and thus the bandwidth demand required in the fronthaul between the digital unit and the radio unit has increased significantly. In a deployment such as centralized/cloud radio access network (C-RAN), the DU may be implemented to perform functions for packet data convergence protocol (PDCP), radio link control (RLC), media access control (MAC), and physical (PHY), and RU may be implemented to further perform functions for PHY layer in addition to radio frequency (RF) functions.

The DU 310 may be in charge of upper layer functions of a wireless network. For example, the DU 310 may perform functions of MAC layer and a part of PHY layer. Herein, a part of the PHY layer refers to a function of the PHY layer performed at a higher level among the functions of the PHY layer, and may include, for example, channel encoding (or channel decoding), scrambling (or descrambling), modulation (or demodulation), and layer mapping (or layer demapping). According to an embodiment, the DU 310 may perform only bit arrangement for resource mapping during among modulation operations. Bit arrangement may refer, for example, to an operation of distinguishing bits into symbol units according to the modulation order, in order to map bits to REs. Among the modulation operation, complex mapping converting bits into complex-valued symbols may be performed by the RU 320. In addition, according to an embodiment, if the DU 310 complies with the O-RAN standard, it may be referred to as an O-DU (O-RAN DU). The DU 310 may be replaced with a first network entity for a base station (e.g., gNB) in embodiments of the present disclosure, if necessary.

The RU 320 may be in charge of lower layer functions of a wireless network. For example, the RU 320 may perform a part of the PHY layer, and RF function. Herein, a part of the PHY layer refers to a function of the PHY layer performed at performed at a relatively lower level than the DU 310, and may include, for example, iFFT conversion (or FFT conversion), CP insertion (CP removal), and digital beamforming. According to an embodiment, the RU 320 may perform complex mapping among modulation operations. The complex mapping may refer, for example, to an operation of converting bits corresponding to symbols into in-phase/quadrature-phase (IQ) signals. The RU 320 may be referred to as access unit (AU), access point (AP), transmission/reception point (TRP), remote radio head (RRH), radio unit (RU), or other terms having equivalent technical meanings. According to an embodiment, if the RU 320 complies with the O-RAN standard, it may be referred to as O-RAN RU (O-RU). The RU 320 may be replaced with a second network entity for a base station (e.g., gNB) in embodiments of the present disclosure, if necessary.

Although FIG. 3A describes that the base station 110 includes the DU 310 and the RU 320, various embodiments of the present disclosure are not limited thereto. The base station according to various embodiments may be implemented in a distributed deployment according to a centralized unit (CU) configured to perform functions of upper layers (e.g., packet data convergence protocol (PDCP), radio resource control (RRC)) of an access network and a distributed unit (DU) configured to perform functions of lower layers. At this time, the distributed unit (DU) may include the digital unit (DU) and the radio unit (RU) of FIG. 1. Between a core (e.g., 5G core (5GC) or next generation core (NGC)) network and a radio network (RAN), the base station may be implemented in a structure in which CU, DU, and RU are arranged in order. An interface between the CU and the distributed unit (DU) may be referred to as an F1 interface.

A centralized unit (CU) may be connected to one or more DUs to perform a function of a higher layer than the DU. For example, the CU may be in charge of radio resource control (RRC) and a function of a packet data convergence protocol (PDCP) layer, and the DU and the RU may be in charge of functions of lower layers. The DU may perform radio link control (RLC), media access control (MAC), and some functions (high PHY) of PHY layer, and the RU may perform remaining functions (low PHY) of the PHY layer. In addition, as an example, a digital unit (DU) may be included in a distributed unit (DU) according to the implementation of distributed deployment of the base station. Hereinafter, unless otherwise defined, it is described that operations of the digital unit (DU) and the RU, but various embodiments of the present disclosure may be applied to both of a base station arrangement including the CU or an arrangement where the DU is directly connected to a core network (e.g., the CU and the DU are integrated into a base station (e.g., NG-RAN node) which is a single entity).

FIG. 3B is a diagram illustrating an example fronthaul interface of an open (O)-radio access network (RAN) according to various embodiments. As a base station 110 according to distributed deployment, eNB or gNB is illustrated.

Referring to FIG. 3B, the base station 110 may include an O-DU 351 and O-RUs 353-1, . . . , and 353-n. Hereinafter, for convenience of explanation, an operation and a function of the O-RU 353-1 may be understood as a description of each of other O-RUs (e.g., O-RU 353-n).

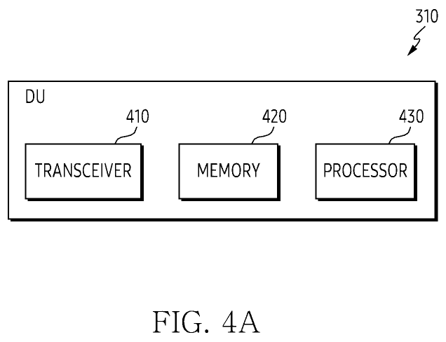

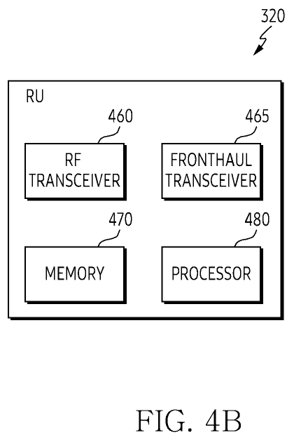

The O-DU 351 is a logical node including functions among function of a base station (e.g., eNB, gNB) according to FIG. 4 to be described in greater detail below, except for functions allocated exclusively to the O-RU 353-1. The O-DU 351 may control operations of the O-RUs 353-1, . . . , and 353-n. The O-DU 351 may be referred to as a lower layer split (LLS) central unit (CU). The O-RU 353-1 is a logical node including a subset among the functions of a base station (e.g., eNB, gNB) according to FIG. 4 to be described later. The real-time aspect of the control plane (C-plane) communication and user plane (U-plane) communication with the O-RU 353-1 may be controlled by the O-DU 351.

The O-DU 351 may perform communication with the O-RU 353-1 through an LLS interface. The LLS interface corresponds to a fronthaul interface. The LLS interface refers to a logical interface between the O-DU 351 and the O-RU 353-1 using lower layer functional split (e.g., intra-PHY-based functional split). The LLS-C between the O-DU 351 and the O-RU 353-1 provides the C-plane through the LLS interface. The LLS-U between the O-DU 351 and the O-RU 353-1 provides the U-plane through the LLS interface.

In FIG. 3B, entities of the base station 110 have been described as O-DU and O-RU to describe O-RAN. However, these designations are not to be understood as limiting the various embodiments of the present disclosure. In various embodiments described with reference to FIGS. 3A to 16, operations of the DU 310 may also be performed by the O-DU 351. A description of the DU 310 may be applied to the O-DU 351. Likewise, in embodiments described with reference to FIGS. 4A to 16, operations of the RU 320 may also be performed by the O-RU 353-1. A description of the RU 320 may be applied to the O-RU 353-1.

FIG. 4A is a block diagram illustrating an example configuration of a distributed unit (DU) according to various embodiments. The configuration illustrated in FIG. 4A may be understood as a configuration of the DU 310 of FIG. 3A (or the O-DU 351 of FIG. 3B) as a part of a base station. Hereinafter, the terms ‘ . . . unit’ and ‘ . . . er’ used below refer to a unit processing at least one function or operation, which may be implemented by hardware or software, or a combination of hardware and software.

Referring to FIG. 4A, a DU 310 includes a transceiver (e.g., including communication circuitry) 410, memory 420, and a processor (e.g., including processing circuitry) 430.

The transceiver 410 may include various communication circuitry and perform functions for transmitting and receiving a signal in a wired communication environment. The transceiver 410 may include a wired interface for controlling a direct connection between a device and a device through a transmission medium (e.g., copper wire, optical fiber). For example, the transceiver 410 may transmit an electrical signal to another device through a copper wire or perform conversion between an electrical signal and an optical signal. The DU 310 may communicate with a radio unit (RU) through the transceiver 410. The DU 310 may be connected to a core network or a CU of a distributed deployment through the transceiver 410.

The transceiver 410 may perform functions for transmitting and receiving a signal in a wireless communication environment. For example, the transceiver 410 may perform a conversion function between a baseband signal and a bit string according to a physical layer specification of a system. For example, upon transmitting data, the transceiver 410 generates complex-valued symbols by encoding and modulating a transmission bit string. In addition, upon receiving data, the transceiver 410 restores a received bit string by demodulating and decoding a baseband signal. In addition, the transceiver 410 may include a plurality of transmission/reception paths. In addition, according to an embodiment, the transceiver 410 may be connected to a core network or to other nodes (e.g., integrated access backhaul (IAB)).

The transceiver 410 may transmit and receive a signal. For example, the transceiver 410 may transmit a management plane (M-plane) message. For example, the transceiver 410 may transmit a synchronization plane (S-plane) message. For example, the transceiver 410 may transmit a control plane (C-plane) message. For example, the transceiver 410 may transmit a user plane (U-plane) message. For example, the transceiver 410 may receive the U-plane message. Although only the transceiver 410 is illustrated in FIG. 4A, the DU 310 may include two or more transceivers according to another implementation.

The transceiver 410 transmits and receives a signal as described above. Accordingly, all or some of the transceiver 410 may be referred to as a ‘communication unit’, a ‘transmission unit’, a ‘reception unit’, or a ‘transmission/reception unit’. In addition, in the following description, transmission and reception performed through a wireless channel are used to include the processing as described above being performed by the transceiver 410.

Although not illustrated in FIG. 4A, the transceiver 410 may further include a backhaul transceiver for connection with a core network or another base station. The backhaul transceiver provides an interface for performing communication with other nodes in the network. In other words, the backhaul transceiver converts a bit string transmitted from a base station to another node, such as another access node, another base station, an upper node, and a core network into a physical signal, and converts a physical signal received from another node into a bit string.

The memory 420 stores a basic program, an application program, and data such as configuration information for an operation of the DU 310. The memory 420 may be referred to as a storage unit. The memory 420 may be configured with a volatile memory, a nonvolatile memory, or a combination of the volatile memory and the nonvolatile memory. Further, the memory 420 provides stored data according to a request from the processor 430.

The processor 430 may include various processing circuitry and controls overall operations of the DU 310. The processor 480 may be referred to as a control unit. For example, the processor 430 transmits and receives a signal through the transceiver 410 (or through a backhaul communication unit). In addition, the processor 430 writes and reads data in the memory 420. In addition, the processor 430 may perform functions of a protocol stack required in a communication standard. Although only the processor 430 is illustrated in FIG. 4A, the DU 310 may include two or more processors according to another implementation. For example, the processor 430 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

A configuration of the DU 310 illustrated in FIG. 4A is merely an example, and the example of the DU performing various embodiments of the present disclosure is not limited to the configuration illustrated in FIG. 4A. In various embodiments, some configurations may be added, deleted, or changed.

FIG. 4B is a block diagram illustrating an example configuration of a radio unit (RU) according to various embodiments. A configuration illustrated in FIG. 4B may be understood as a configuration of the RU 320 of FIG. 3A or the O-RU 353-1 of FIG. 3B as a part of a base station. Hereinafter, the terms ‘ . . . unit’ and ‘ . . . er’ used below refer to a unit processing at least one function or operation, which may be implemented by hardware or software, or a combination of hardware and software.

Referring to FIG. 4B, the RU 320 includes an RF transceiver (e.g., including communication circuitry) 460, a fronthaul transceiver (e.g., including communication circuitry) 465, memory 470, and a processor (e.g., including processing circuitry) 480.

The RF transceiver 460 may include various communication circuitry and performs functions for transmitting and receiving a signal through a wireless channel. For example, the RF transceiver 460 up-converts a baseband signal into an RF band signal and then transmits it through an antenna, and down-converts an RF band signal received through the antenna into a baseband signal. For example, the RF transceiver 460 may include a transmission filter, a reception filter, an amplifier, a mixer, an oscillator, a DAC, an ADC.

The RF transceiver 460 may include a plurality of transmission/reception paths. Furthermore, the RF transceiver 460 may include an antenna unit. The RF transceiver 460 may include at least one antenna array including a plurality of antenna elements. In terms of hardware, the RF transceiver 460 may include a digital circuit and an analog circuit (e.g., a radio frequency integrated circuit (RFIC)). Herein, the digital circuit and the analog circuit may be implemented as a single package. In addition, the RF transceiver 460 may include a plurality of RF chains. The RF transceiver 460 may perform beamforming. In order to provide directionality to a signal to be transmitted and received according to the setting of the processor 480, the RF transceiver 460 may apply beamforming weights to the signal. According to an embodiment, the RF transceiver 460 may include a radio frequency (RF) block (or RF unit).

The RF transceiver 460 may transmit and receive a signal on a radio access network. For example, the RF transceiver 460 may transmit a downlink signal. The downlink signal may include synchronization signal (SS), reference signal (RS) (e.g., cell-specific reference signal (CRS), demodulation (DM)-RS), system information (e.g., MIB, SIB, remaining system information (RMSI), other system information (OSI)), configuration message, control information or downlink data. In addition, for example, the RF transceiver 460 may receive an uplink signal. The uplink signal may include a random access-related signal (e.g., random access preamble (RAP)) (or message 1 (Msg1), message 3 (Msg3)), a reference signal (e.g., sounding reference signal (SRS), DM-RS), or a power headroom report (PHR). Although only the RF transceiver 460 is illustrated in FIG. 4B, the RU 320 may include two or more RF transceivers according to another implementation.

According to various embodiments, the RF transceiver 460 may transmit an RIM-RS. The RF transceiver 460 may transmit a first type of RIM-RS (e.g., RIM-RS type 1 of 3GPP) to inform the detection of remote interference. The RF transceiver 460 may transmit a second type of RIM-RS (e.g., RIM-RS type 2 of 3GPP) to inform the presence or absence of remote interference.

The fronthaul transceiver 465 may include various communication circuitry and transmit and receive a signal. According to an embodiment, the fronthaul transceiver 465 may transmit and receive a signal on a fronthaul interface. For example, the fronthaul transceiver 465 may receive a management plane (M-plane) message. For example, the fronthaul transceiver 465 may receive a synchronization plane (S-plane) message. For example, the fronthaul transceiver 465 may receive a control plane (C-plane) message. For example, the fronthaul transceiver 465 may transmit a user plane (U-plane) message. For example, the fronthaul transceiver 465 may receive a U-plane message. Although only the fronthaul transceiver 465 is illustrated In FIG. 4B, the RU 320 may include two or more fronthaul transceivers according to another implementation.

As described above, the RF transceiver 460 and the fronthaul transceiver 465 transmit and receive a signal. Accordingly, all or some of the RF transceiver 460 and the fronthaul transceiver 465 may be referred to as a ‘communication unit’, a ‘transmission unit’, a ‘reception unit’, or a ‘transmission/reception unit’. Furthermore, in the following description, transmission and reception performed through a wireless channel are used to include the processing as described above being performed by the RF transceiver 460. In the following description, transmission and reception performed through a wireless channel are used to include the processing as described above being performed by the RF transceiver 460.

The memory 470 stores a basic program, an application program, and data such as configuration information for an operation of the RU 320. The memory 470 may be referred to as a storage unit. The memory 470 may be configured with a volatile memory, a nonvolatile memory, or a combination of the volatile memory and the nonvolatile memory. Further, the memory 470 provides stored data according to a request from the processor 480. According to an embodiment, the memory 470 may include a memory for a condition, a command, or a setting value related to an SRS transmission scheme.

The processor 480 may include various processing circuitry and controls overall operations of the RU 320. The processor 480 may be referred to as a control unit. For example, the processor 480 transmits and receives a signal through the RF transceiver 460 or the fronthaul transceiver 465. In addition, the processor 480 writes and reads data in the memory 470. In addition, the processor 480 may perform functions of a protocol stack required by a communication standard. Although only processor 480 is illustrated in FIG. 4B, the RU 320 may include two or more processors according to another implementation. The processor 480, which may implement or execute an instruction set or code stored in the memory 470, may implement or execute an instruction/code at least temporarily resided in the processor 480 or a storage space storing instruction/code, or part of circuitry of the processor 480. In addition, the processor 480 may include various modules for performing communication. The processor 480 may control the RU 320 to perform operations according to embodiments to be described in greater detail below. Further, the processor 480 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

A configuration of the RU 320 illustrated in FIG. 4B is merely an example, and the example of the RU performing various embodiments of the present disclosure is not limited to the configuration illustrated in FIG. 4B. In various embodiments, some configurations may be added, deleted, or changed.

As described above, in order to manage remote interference, a base station may transmit RIM-RS. A victim node may transmit the first type of RIM-RS (e.g., RIM-RS type 1 of 3GPP). The first type of RIM-RS may be used to indicate that remote interference exists in a victim cell, for example, to inform that there is a ducting phenomenon. In a specific framework (e.g., framework of FIG. 2B), an aggressor node may transmit a second type of RIM-RS (e.g., RIM-RS type 2 of 3GPP). The second type of RIM-RS may be used to inform the victim cell that there is a ducting phenomenon. Unlike the first type of RIM-RS, the second type of RIM-RS may not transmit additional information (e.g., the number of symbols). Hereinafter, the description of the RIM-RS structure described below may be applied to the first type of RIM-RS and the second type of RIM-RS.

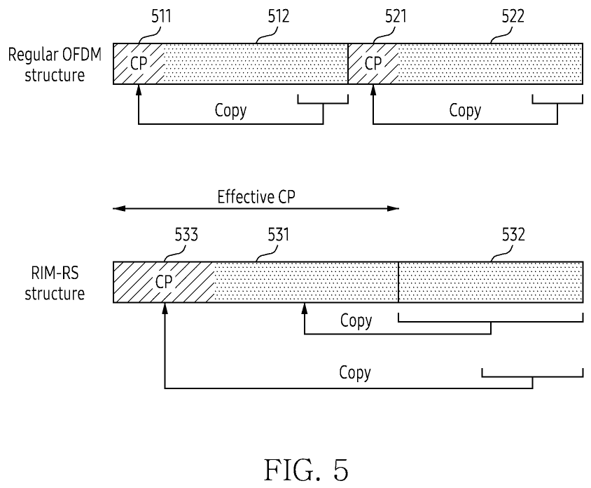

FIG. 5 is a diagram illustrating an example of remote interference management (RIM)-reference signal (RS) structure according to various embodiments. The RIM-RS is intended to inform remote interference, and an RIM-RS structure is required to be able to detect the RIM-RS without OFDM symbol synchronization between the aggressor and the victim.

Referring to FIG. 5, a structure of a regular OFDM symbol may include a data symbol and a cyclic prefix (CP). Herein, the general OFDM symbol may refer, for example, to a symbol used to transmit bits of other NR channels (e.g., physical downlink shared channel (PDSCH), physical downlink control channel (PDCCH), physical uplink shared channel (PUSCH), physical uplink control channel (PUCCH)) except for RIM-RS. The data symbol may refer, for example, to a complex number symbol corresponding to data payload, and on which complex mapping has been performed. For example, a first OFDM symbol may include a CP 511 and a data symbol 512. The CP 511 corresponds to one or more samples of the data symbol 512. The symbol 512 refers to a complex number symbol on which complex mapping is performed. The second OFDM symbol may include a CP 521 and a data symbol 522. The CP 521 corresponds to one or more samples of the data symbol 522.

The RIM-RS may be transmitted through two consecutive symbols. The two consecutive symbols may include a first RIM-RS symbol 531 and a second RIM-RS symbol 532. Herein, the symbol may refer, for example, to a complex-valued symbol corresponding to bits, not a resource length including the CP. Useful parts of each symbol may be the same. The useful part may refer to data payload. The data symbol of the first RIM-RS symbol 531 and the data symbol of the second RIM-RS symbol 532 may be the same. In the RIM-RS, the CP is not located in front of each symbol, but the RIM-RS CP 533 may be located at a front end of the first symbol 531 located in front among the two symbols. Copied samples used for the RIM-RS CP 533 are located at an end portion of the second symbol of the RIM-RS. Since a length of the CP is relatively long, it is possible to detect the RIM-RS without estimating a separate OFDM symbol timing.

In the 5G wireless communication system, for large-capacity data transmission, the bandwidth of radio channels and the number of antennas increase, and the interface bandwidth between the DU and the RU also increase significantly. In addition, since one DU should transmit traffic to a plurality of RUs, the required interface bandwidth between the DU and RU increases linearly with respect to the number of RUs. In a general functional split system, in order to reduce the required interface bandwidth between the DU and the RU, the DU generates a signal of a frequency domain and generates a signal of a time domain through inverse fast fourier transform and CP insertion in the RU. In the OFDM systems, a guard subcarrier is inserted to reduce channel interference. If only the signal of the frequency domain, from which the guard subcarrier is excluded, is transmitted, the required bandwidth between the DU and RU may be reduced. Together with the function split in which the DU processes a signal in the frequency domain and the RU processes a signal in the time domain, various compression scheme to reduce the required bandwidth by compressing traffic between DU and RU have been proposed. These traffic compression techniques may be classified into a loss compression technique and a lossless compression technique.

The loss compression technique may refer, for example, to a method in which after modulation is performed in the DU, a complex-valued symbol with a channel gain applied is generated, low-critical lower bit information is removed, and remaining bits are transmitted to the RU. For example, it is assumed that the lower 8 bits are removed from 16 bits, and remaining top 8 bits are transmitted to the RU. The required bandwidth between the DU and the RU may be reduced by 50%. However, in the RU, the symbol should be restored only with the upper 8-bit information. The loss compression technique has the disadvantage of causing information distortion between the DU and the RU.

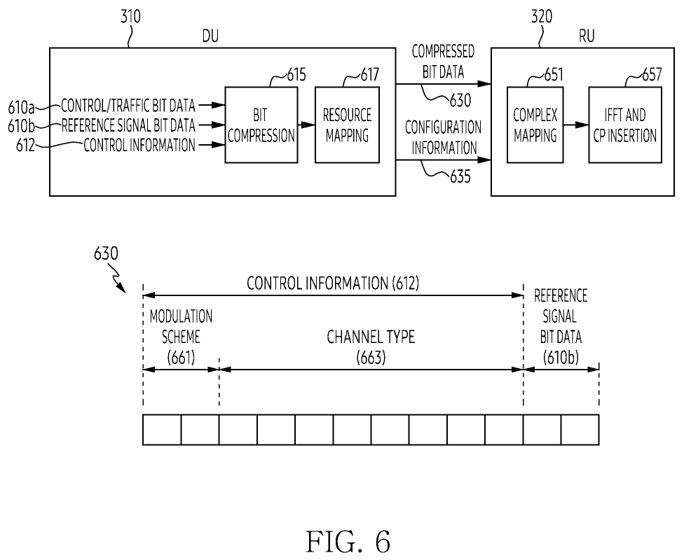

The lossless compression technique may be divided into a method in which a complex-valued symbol is generated in the DU and data (hereinafter, compressed bit data) to which lossless compression based on information theory is applied to the complex-valued symbol is transmitted to the RU, and a method in which bit data is transmitted in the DU to the RU and the RU generates a complex-valued symbol by reflecting modulation and channel gain. The lossless compression based on information theory has the disadvantage of being difficult to process large amounts of data in real time because it requires a lot of computation for compression and restoration. In the lossless compression in which the RU performs modulation using compressed bit data received from the DU, the modulation function of the DU is transferred to the RU. In terms of the system, the required bandwidth between the DU and the RU may be efficiently reduced without an additional increase in computational complexity. In order for the RU to perform modulation (it may refer, for example, to a process of generating an IQ signal through complex mapping) and reflect the channel gain, additional control information (modulation method, channel type) is required. The DU may transmit control information to the RU together with bit data. The compressed data transferred from the DU to the RU may include bit data and control information. For example, the DU may compress bit data and control information into 10 bits. The DU may transmit compressed bit data of 10 bits to the RU. The RU may perform complex mapping of modulation, based on the compressed bit data. Herein, the complex mapping may refer, for example, to an operation of converting bits corresponding to one symbol into an IQ signal. Through complex mapping of modulation, the RU may generate a 16-bit complex-valued symbol, that is, a complex-valued symbol with a real part of 16-bit and an imaginary part of 16-bit. Accordingly, the RU may reduce the required bandwidth between the DU and the RU to 31.25% (=10/32) compared to the uncompressed one. Hereinafter, functions of the lossless compression technique between the DU and the RU will be described in greater detail with reference to FIG. 6.

FIG. 6 is a diagram illustrating an example configuration per network entity for compressed bit data transmission according to various embodiments. The network entity may include a DU 310 or an RU 320.

Referring to FIG. 6, the DU 310 may obtain bit data corresponding to information to be transmitted by the RU 320. The DU 310 may obtain bit data by receiving bits from an upper node or generating a signal at the DU 310. According to an embodiment, the DU 310 may obtain control/traffic bit data 610a. The control/traffic bit data 610a may include at least one of control bit data and traffic bit data. Herein, the control bit data may include one or more bits related to a control channel (e.g., physical downlink control channel (PDCCH)). The traffic bit data may include one or more bits related to a data channel (e.g., physical downlink shared channel (PDSCH)). According to an embodiment, the DU 310 may obtain reference signal bit data 610b. According to an embodiment, reference signal bit data may include one or more bits corresponding to the RIM-RS.

The DU 310 may generate control information 612. The DU 310 may generate control information 612 related to bit data. The control information 612 may generate control information 612 for the control bit data 610a, the traffic bit data 610a, or the reference signal bit data 610b. The control information 612 may indicate a channel type of bit data and a modulation method for bit data.

The DU 310 may perform bit compression 615, based on at least one of the control/traffic bit data 610a, the reference signal bit data 610b, or the control information 612. The DU 310 may generate compressed bit data 630 including the control information 612 in addition to the control/traffic bit data 610a or the reference signal bit data 610b. The DU 310 may perform resource mapping 617 on the generated compressed bit data 630. The DU 310 may sort bits of compressed bit data. In the present disclosure, modulation may include bit alignment and complex mapping 651. Herein, the bit alignment may refer to an operation of distinguishing bits by a size of symbol units (e.g., QPSK is 2-bit and 16 QAM is 4-bit) corresponding to a modulation order to map bits to the RE. The complex mapping 651 refers to an operation of converting bits aligned to correspond to one symbol into an IQ signal. The converted IQ signal may be referred to as a complex-valued symbol. The DU 310 may perform bit alignment with respect to compressed bit data. The DU 310 maps bits corresponding to one symbol to a resource element (RE), which is a frequency-time resource, and transmits the bits to the RU 320. For example, in case that the modulation scheme is QPSK, the DU 310 may map two bits to one RE.

The DU 310 may transmit the generated compressed bit data 630 to the RU 320. The DU 310 may transmit the generated compressed bit data 630 to the RU 320 through a fronthaul interface. The DU 310 may transmit configuration information 635 to the RU 320. The configuration information 635 may include information used for signal processing in the RU 320. The configuration information 635 may include information on a gain for each channel. The configuration information 635 may include information on precoding (e.g., a precoding matrix). In addition, the configuration information 635 may include a channel-specific gain, a precoding matrix, and other additional information. The configuration information 635 may be transmitted only once for a first time or may be updated as necessary. Accordingly, the transmission frequency of the configuration information 635 may be lower than that of the compressed bit data 630. Transmission of the configuration information 635 may be performed with a bandwidth lower than that of the compressed bit data 630. The RU 320 may obtain a modulation scheme 661 and a channel type 663 based on the control information 612 of the compressed bit data 630.

The RU 320 may perform complex mapping 651. The RU 320 may generate an IQ signal corresponding to the bit data 630. The RU 320 may generate a complex-valued symbol corresponding to the bit data 630, based on the modulation scheme 661 and the channel type 663. The RU 320 may perform IFFT and CP insertion 657. The RU 320 may apply the obtained channel gain and precoding matrix to the generated complex-valued symbol, based on the configuration information 635. The RU 320 may generate a RIM-RS symbol based on an inverse fast fourier transform (IFFT) to be applied to the modulated complex-valued symbol, and may generate an OFDM baseband signal by inserting a cyclic prefix (CP). The baseband signal may be a time domain signal.

The RIM-RS according to various embodiments corresponds to a reference signal. The RIM-RS may be generated based on bit data of 2-bit. The RIM-RS may be generated based on Quadrature Phase Shift Keying (QPSK). In the lossless compression scheme of FIG. 6, the DU 310 may transmit 2 bits of reference signal bit data 610b related to the RIM-RS to the RU 320. The RU 320 may perform the QPSK modulation on 2 bits, based on the control information 612. Herein, bit alignment for RE mapping may be performed by the DU 310. The RU 320 may generate a complex-valued symbol for the RIM-RS based on a channel gain obtained through the configuration information 635. The compressed bit data 630 transmitted from the DU 310 to the RU 320 may include bit data (e.g., reference signal bit data 610b) and the control information 612. For example, the number of bits of the compressed bit data 630 may be 10. An index for the modulation scheme 661 and an index for the channel type 663 may be determined by a predefined setting (e.g., pre-setting an M-plane of an O-RAN) between the DU 310 and the RU 320. As an example, the index ‘00’ of the modulation scheme 661 may refer, for example, to the QPSK modulation. The index ‘101100’ of the channel type 663 may indicate the RIM-RS.

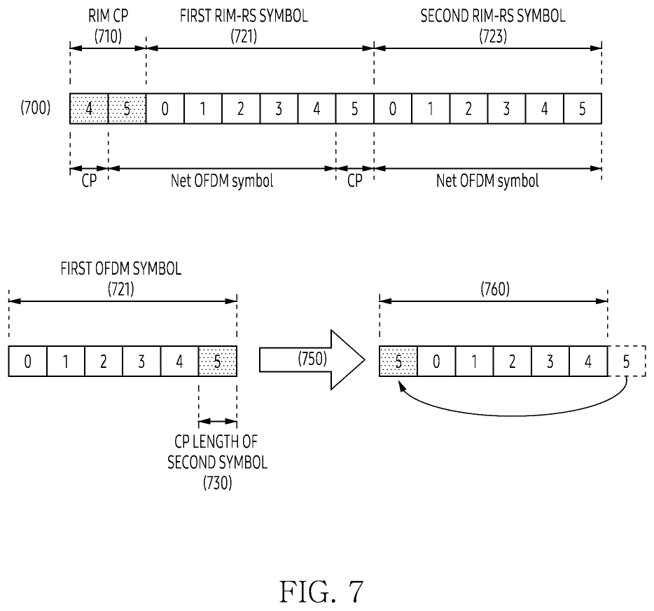

FIG. 7 is a diagram illustrating an example of a cyclic shift according to various embodiments. As mentioned in FIG. 5, for detecting the RIM-RS, it has been standardized to connect two identical data symbols and use a cyclic prefix (CP) longer than that of a general OFDM symbol. A CP inserter of RU's hardware developed before RIM-RS standardization may only add one CP to one OFDM symbol. Therefore, in order to generate an OFDM symbol of the RIM-RS in which the first data symbol and the second data symbol are connected through the existing CP inserter, an additional process is required. The additional process may be referred to as cyclic shift.

Referring to FIG. 7, the RIM-RS 700 may include a RIM-RS CP 710, a first RIM-RS symbol 721, and a second RIM-RS symbol 723. For example, the first RIM-RS symbol 721 may include six sample groups. Each sample group may include one or more time samples. The first RIM-RS symbol 721 may include sample group #0, sample group #1, sample group #2, sample group #3, sample group #4, and sample group #5. The second RIM-RS symbol 723 may include six sample groups. The second RIM-RS symbol 723 may include sample group #0, sample group #1, sample group #2, sample group #3, sample group #4, and sample group #5. The sample groups of the second RIM-RS symbol 723 may be identical to the sample groups of the first RIM-RS symbol 721. The RIM-RS CP 710 may be configured to be longer than the CP length of a general OFDM symbol. For example, the RIM-RS CP 710 may include some sample groups (e.g., sample groups #4, #5) among the sample groups of the second RIM-RS symbol 723.

The CP inserter for the general OFDM symbol inserts one sample group of the data symbol in front. Herein, the general OFDM symbol may refer, for example, to a symbol used to transfer bits of other NR channels (e.g., PDSCH, PDCCH, PUSCH, PUCCH) except for RIM-RS. The data symbol may refer, for example, to a complex-valued symbol corresponding to the data payload and on which complex mapping has been performed. In order to implement the RIM-RS CP 710 through the CP inserter for the general OFDM symbol, a cyclic shift is required before CP insertion.

The RU may perform a cyclic shift 750 on a portion of a data symbol. For example, the cyclic shift may be performed on the sample group #5, which is located at the end among the six sample groups of the first data symbol 721. When assuming the general OFDM symbol, a length of the sample group #5 may correspond to a CP length 730 of the second data symbol 723. After cyclically shifting the first data symbol 721 of the RIM-RS backward as many as the CP length 730 of the second data symbol 723, the RU may input the cyclically shifted first data symbol 760 to the CP inserter. Since the CP inserter inserts the last sample group of the input symbol in front, the sample group #4 is added to the cyclically shifted first data symbol 760. The CP inserter may output sample group #4, sample group #5, sample group #0, sample group #1, sample group #2, sample group #3, and sample group #4. The RU may input the second data symbol 723 to the CP inserter. The sample group #5 is added to the second data symbol 723. The CP inserter may output sample group #5, sample group #0, sample group #1, sample group #2, sample group #3, sample group #4, and sample group #5. The RU may generate the RIM-RS 700, based on the CP inserter of the general OFDM symbol, by performing a cyclic shift on the first data symbol of the RIM-RS.

Since RIM-RS is used for the purpose of detecting remote interference signals, its OFDM symbol structure is different from the existing NR OFDM symbol structure, and its carrier frequency is also operated differently from NR. Therefore, the RIM-RS is required to perform separate resource mapping, IFFT, CP insertion, and carrier frequency modulation that are different from the existing NR channels. However, it is inefficient from the system perspective to have a separate processing chain for processing only RIM-RS. Therefore, as the RU generates RIM-RS based on the processing chain (e.g., CP inserter) of the existing NR channel, the cyclic shift according to various embodiments may increase the efficiency of the system.

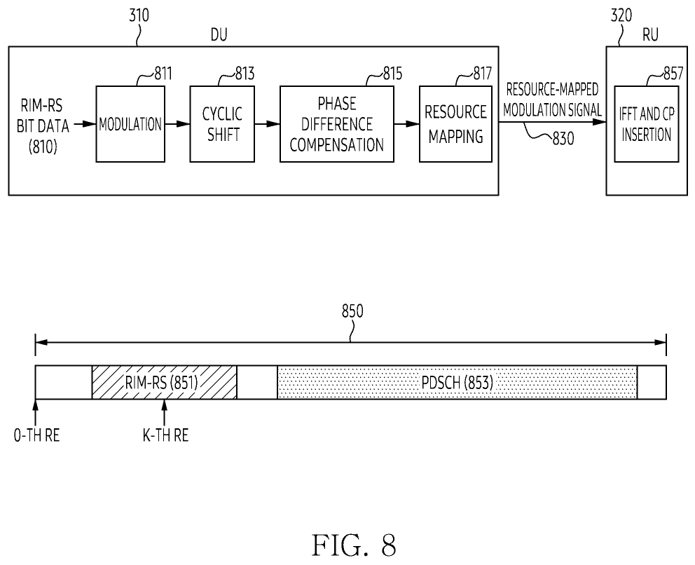

FIG. 8 is a block diagram illustrating an example configuration per network entity for downlink transmission according to various embodiments. A network entity may include a DU 310 or a RU 320.

Referring to FIG. 8, in order to increase frequency utilization, the RIM-RS and channels (hereinafter referred to as general NR channels) other than the RIM-RS may be allocated to the same OFDM symbol using different frequency resources. For example, in frequency domain 850, PDSCH 853 may be allocated to a frequency region other than a frequency region to which the RIM-RS 851 is mapped.

In the general function split, the DU 310 processes a signal in the frequency domain, and the RU 320 processes a signal in the time domain after performing IFFT. As illustrated in FIG. 7, since the CP length and the data symbol length correspond to the time order, the cyclic shift may be performed based on signal processing of the time domain in the RU 320. However, in case that the RIM-RS 851 and a general NR channel (e.g., PDSCH) are mixed on the frequency domain 850, the cyclic shift for the RIM-RS is required to be selectively applied. However, it is not easy to separate frequency resources in the time domain. Therefore, selective cyclic shift for RIM-RS is required through signal processing in the frequency domain. Hereinafter, a procedure of the DU 310 and the RU 320 for generating the RIM-RS 851 is described based on the processing chain for general NR channels.

The DU 310 may generate RIM-RS bit data 810. The DU 310 may perform modulation 811. The DU 310 may perform QPSK modulation on the RIM-RS bit data 810. The DU 310 may generate a complex-valued symbol based on the QPSK modulation. The DU 310 may perform cyclic shift 813. The DU 310 may perform cyclic shift on the complex-valued symbol. As a result, it is a cyclic shift in the time domain, but it corresponds to a phase rotation in the frequency domain. The DU 310 may rotate a phase of complex-valued symbol for each RE of the RIM-RS. The DU 310 may perform a phase difference compensation 815. The DU 310 may perform a phase difference compensation for the cyclic shift result. Herein, the phase difference compensation may refer, for example, to an operation of compensating for a phase difference caused by a difference between a carrier frequency of the general NR channel and a carrier frequency of the RIM-RS. After that, the DU 310 may perform resource mapping 817.

The DU 310 may transmit a modulation signal 830 to the RU 320, based on the result of resource mapping 817. The resource-mapped modulation signal 830 may refer, for example, to an IQ signal corresponding to the RIM-RS. For example, the resource-mapped modulation signal 830 may include a real part of 16-bit and an imaginary part of 16-bit. Thereafter, the RU 320 may perform IFFT and CP insertion 857. The RU 320 may generate OFDM baseband signal of the RIM-RS through IFFT conversion and CP insertion to the received modulation signal 830. Although not illustrated in FIG. 8, the RU 320 may perform precoding. The RU 320 may generate an OFDM baseband signal of the RIM-RS through precoding, IFFT conversion, and CP insertion to the received modulation signal 830.

In FIG. 6, a lossless compression scheme between DU-RU is described, in which other functions (e.g., complex mapping, IQ signal generation) of modulation except for bit alignment for resource mapping are performed in the RU. In FIG. 8, a method for generating RIM-RS based on a processing chain of a general NR channel is described. However, since modulation, cyclic shift, and phase difference compensation are performed in the DU in FIG. 8, it is difficult to achieve the lossless compression scheme illustrated in FIG. 6 as it is. Therefore, in order to generate RIM-RS through a processing chain of the general NR channel and bit data according to the lossless compression technique, processing operations for the RIM-RS need to be performed in the RU. For example, among the modulation functions, in addition to bit alignment for resource mapping, other functions (e.g., complex mapping, IQ signal generation), cyclic shift, and phase difference compensation need to be performed in the RU.

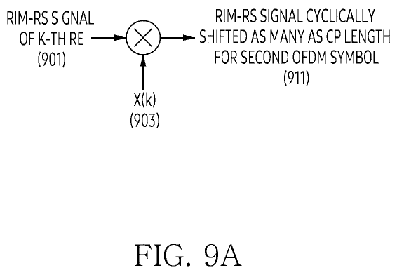

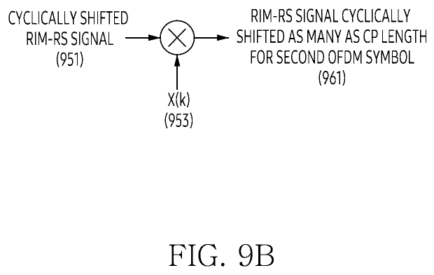

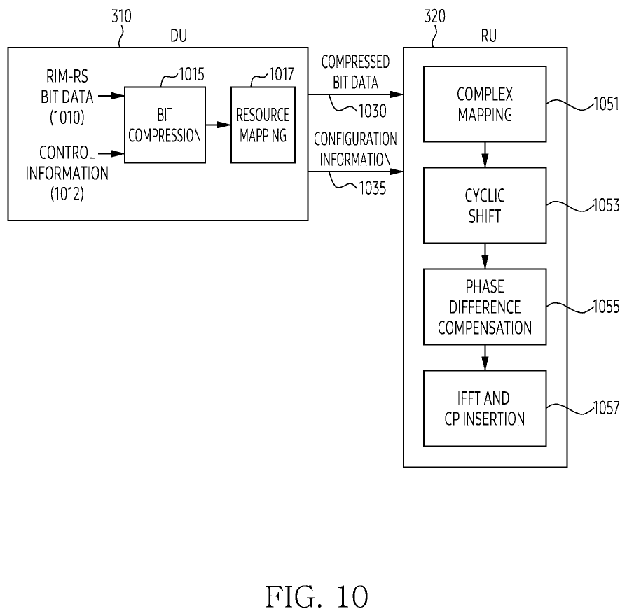

Hereinafter, in FIGS. 9A and 9B, functions for generating RIM-RS from bit data provided by the lossless compression scheme are described. In FIG. 10, the overall operations of DU and RU are described in greater detail.

FIG. 9A is a diagram illustrating an example of a cyclic shifter according to various embodiments. A cyclic shifter according to embodiments may be implemented by an RU (e.g., the RU 320 of FIG. 3A). The cyclic shifter may be implemented in a shape of hardware within the RU, software of a processor within the RU, or a combination of hardware and software. In order to reduce the required bandwidth between DU-RU through a lossless compression scheme, the RU may perform a cyclic shift for the RIM-RS.

Referring to FIG. 9A, the cyclic shifter may output a cyclically shifted RIM-RS signal 911 by performing phase rotation on the RIM-RS signal 901. In case that the RIM-RS signal 901 is mixed with the NR channel (e.g., PDSCH) in the frequency domain, the cyclic shift for the RIM-RS signal 901 should be selectively applied. However, frequency resource split is not possible in the time domain. Therefore, the cyclic shifter according to various embodiments may perform a phase rotation in the frequency domain, instead of the cyclic shift in the time domain. The cyclic shifter of the RU may perform a selective phase rotation for the RIM-RS through signal processing in the frequency domain. The cyclic shifter may rotate a phase of the RIM-RS signal 901, by multiplying the RIM-RS signal assigned to k-th RE by a complex value x (k) (903). For example, the complex value x (k) of the cyclic shifter may be determined based on the following Equations.

$$x ( k ) = exp ( - j * 2 * pi * n\_cp \_l1 * k\_prime / n\_iFFT ) \qquad [ Equation 1 ]$$

$$k\_prime = ( k + ( n\_iFFT - n\_RB * 6 ) ) \% n\_iFFT \qquad [ Equation 2 ]$$

n-cp-l1 may refer, for example, to a CP length of a second RIM-RS symbol of the RIM-RS, n_iFFT may refer, for example, to an iFFT size, and n_RB may refer, for example, to the total number of RBs (resource blocks) of the bandwidth including RIM-RS. Each RB includes 12 REs. ‘k’ indicates an index of corresponding RE within a bandwidth. exp (·) is an exponential function and % may refer, for example, to a modulo operator.

In summary, the cyclic shifter may perform a cyclic shift for the RIM-RS through a phase rotation in the frequency domain. Through the cyclic shift, the RU may insert a CP (e.g., the RIM-RS CP 710) of the RIM-RS into the RIM-RS symbol (e.g., the first RIM-RS symbol 721, the second RIM-RS symbol 723), based on the CP inserter of the general NR channel.

FIG. 9B is a diagram illustrating an example of a phase difference compensator according to various embodiments. The phase difference compensator according to embodiments may be implemented by an RU (e.g., the RU 320 of FIG. 3A). The phase difference compensator may be implemented in a form of hardware within the RU, software of a processor within the RU, or a combination of hardware and software. In order to reduce the required bandwidth between DU-RU through a lossless compression scheme, the RU may perform a phase difference compensation for the RIM-RS.

Referring to FIG. 9B, the phase difference compensator may output a compensated RIM-RS signal 961 by performing a phase difference compensation on the cyclically shifted RIM-RS signal 951. In the 5G wireless communication system, a phase of a carrier frequency at a transmission OFDM symbol body start point is standardized to be 0 degrees, in order to enable channel estimation even if a terminal receives a carrier frequency different from that of the base station. If the RIM-RS is transmitted based on the same modulation chain as the general NR channel, the RU transmits the RIM-RS at the carrier frequency of the general NR channel. Therefore, a compensation for a phase difference between the carrier frequency of the general NR channel and the carrier frequency of the RIM-RS is required. In addition, a phase difference caused by a difference between OFDM symbol lengths of the general NR channel and the RIM-RS is also required to be compensated. Therefore, the phase difference compensator of the RU may compensate the phase difference of the cyclically shifted RIM-RS signal 951 by multiplying the cyclically shifted RIM-RS signal 951 by exp (−j*θₗ₁) 953. θₗ₁ indicates a phase difference of i-th symbol of the RIM-RS. For example, θₗ₁ indicates a phase difference of a first OFDM symbol (e.g., the first RIM-RS symbol 721 of FIG. 7) of the RIM-RS. θₗ₁ indicates a phase difference of a second RIM-RS symbol (e.g., the second RIM-RS symbol (723) of FIG. 7). Herein, θₗ₁ has the same value within the OFDM symbol regardless of an RE index.

FIG. 10 is a block diagram illustrating an example configuration per network entity for RIM-RS transmission according to various embodiments. A network entity may include a DU 310 or a RU 320. In FIG. 10, a device and a method for reducing a required bandwidth of an interface between DU and RU by transmitting a RIM-RS based on a lossless compression scheme are described.

Referring to FIG. 10, the DU 310 may obtain RIM-RS bit data 1010. The RIM-RS bit data 1010 may be determined based on a parameter required to generate a RIM-RS sequence. For example, the RIM-RS bit data 1010 may be configured with 2 bits. The DU 310 may generate control information 1012. The control information 1012 may indicate modulation method for bit data and a channel type for bit data so that RU 320 may generate complex-valued symbol. The control information 1012 may indicate QPSK. The control information 1012 may indicate RIM-RS. For example, an index for the modulation scheme and an index for the channel type 663 may be determined by predefined (e.g., specified) setting (e.g., pre-setting, M-plane of O-RAN) between the DU 310 and the RU 320. For example, the index ‘00’ of the modulation scheme may refer, for example, to QPSK modulation. The index ‘101100’ of the channel type may indicate RIM-RS.

The DU 310 may perform bit compression 1015, based on the RIM-RS bit data 1010 and the control information 1012. The DU 310 may generate compressed bit data 1030 through the bit compression 1015. The DU 310 may perform resource mapping 1017 for bits of the compressed bit data 1030. For the resource mapping 1017, the DU 310 may perform bit alignment for bits of the compressed bit data 1030. The bit alignment may refer, for example, to an operation of distinguishing bits into symbol units according to modulation order, in order to map bits to REs. The RU may be aligned into units of two bits for RIM-RS transmission according to embodiments. Each of two bits is allocated to one RE. That is, the DU 310 may map the compressed bit data to the frequency-time resource to which the RIM-RS is allocated. The compressed bit data may include bits for the RIM-RS.

The DU 310 may transmit the compressed bit data 1030 to the RU 320. The compressed bit data 1030 may include the RIM-RS bit data 1010. In various embodiments, the compressed bit data 1030 may include the control information 1012. Meanwhile, in various embodiments, the compressed bit data 1030 may not include the control information 1012. In this case, information (e.g., channel type, modulation method) indicated by the control information 1012 may be predefined between the DU 310 and the RU 320 or provided by configuration information 1035 described below.

The DU 310 may transmit the configuration information 1035 to the RU 320. The configuration information 1035 may be used by the RU 320 to generate a complex-valued symbol of the RIM-RS from bit data of the RIM-RS, and generate a RIM-RS baseband signal, instead of the DU 310. The RU 320 may generate the RIM-RS baseband signal based on the configuration information 1035. According to an embodiment, the transmission frequency of the configuration information 1035 may be the same as the transmission frequency of the compressed bit data 1030. According to an embodiment, the transmission frequency of the configuration information 1035 may be lower than the transmission frequency of the compressed bit data 1030. Transmission of the configuration information 1035 may be performed with a bandwidth lower than a bandwidth of the compressed bit data 1030. Hereinafter, in order to generate the RIM-RS baseband signal, details of the configuration information 1035 are described together with each functional configuration of the RU 320.

The RU 320 may perform complex mapping 1051. The RU 320 may generate an IQ signal corresponding to the bit data 1030. The RU 320 may obtain a modulation scheme (e.g., QPSK) and a channel type (e.g., RIM-RS) based on the control information 1012 of the compressed bit data 1030. The RU 320 may generate a complex-valued symbol corresponding to the bit data 630, based on a modulation scheme (e.g., QPSK) and a channel type (e.g., RIM-RS). According to an embodiment, the configuration information 1035 may include information on a channel gain of the RIM-RS. Based on the channel gain, the RU 320 may generate a complex-valued symbol according to the modulation.

The RU 320 may perform the cyclic shift 1053. Since frequency resource split is difficult in the time domain, the RU 320 may perform a phase rotation in the frequency domain to be cyclically shifted in the time domain. Hereinafter, the cyclic shift may refer, for example, to a phase rotation in the frequency domain. For the phase rotation, the configuration information 1035 may include various information.

According to an embodiment, the configuration information 1035 may include an indicator for indicating whether a symbol corresponding to the compressed bit data 1030 is a first symbol or a second symbol among two symbols of the RIM-RS. In order to utilize a CP inserter for a general NR channel, the RU 320 according to embodiments may perform cyclic shift on the first RIM-RS. For example, as illustrated in FIG. 7, the cyclic shift 750 is performed only on the first RIM-RS symbol 721. According to a symbol position of the RIM-RS, whether to perform the cyclic shift is performed varies. The RU 320 may perform the cyclic shift of the RIM-RS symbol based on the indicator.

According to an embodiment, the configuration information 1035 may include resource allocation information. That is, the configuration information 1035 may include information related to resource mapping 1017. The resource allocation information may indicate a time resource. For example, the resource allocation information may include a system frame number (SFN) for indicating a radio frame. For example, the resource allocation information may include a subframe number. For example, the resource allocation information may include a slot index. For example, the resource allocation information may include a symbol index. The resource allocation information may indicate a frequency resource. For example, the resource allocation information may include frequency offset information for the RIM-RS. For example, the resource allocation information may include an RE index for the RIM-RS. According to embodiments, a selective cyclic shift for the RIM-RS may be performed based on the resource allocation information. The RU 320 may perform a phase rotation based on identifying the RE to which the RIM-RS is allocated.

According to an embodiment, the configuration information 1035 may include cyclic shift information. For example, the configuration information 1035 may include information on a RIM-RS CP length. Herein, the CP length may refer, for example, to a CP length of a symbol of the rear RIM-RS among the two RIM-RS symbols. At a position of the RE corresponding to the resource allocation information, the RU 320 may perform a phase rotation as many as the RIM-RS CP length.

The RU 320 may perform a phase difference compensation 1055. The phase difference compensation refers to a procedure for compensating for a difference between a carrier frequency of the NR channel and a carrier frequency of the RIM-RS. According to an embodiment, the configuration information 1035 may include phase difference information. The phase difference information may include phase difference information of the first RIM-RS symbol and phase difference information of the second RIM-RS symbol. For example, the configuration information 1035 may include phase difference information for each symbol. The phase difference information may be the same between REs within the same symbol. According to an embodiment, the configuration information 1035 may include information on a reference point of the RIM-RS in each symbol. The RU may calculate a phase difference of the corresponding symbol, based on the difference between the reference point of the RIM-RS and a carrier frequency of another NR channel.

The RU 320 may perform IFFT and CP insertion 1057. The RU 320 may generate a RIM-RS symbol based on IFFT to be applied to modulated complex-valued symbol and insert cyclic prefix (CP) to generate an OFDM baseband signal. According to an embodiment, the configuration information 1035 may include precoding information. The RU 320 may apply precoding to the RIM-RS for which the cyclic shift and the phase difference compensation are completed. According to an embodiment, a precoding matrix may be transmitted once at system startup through configuration information or may be updated if necessary. Based on the precoding information, the RU 320 may apply the precoding matrix to RS sequence. The RU 320 may generate an OFDM baseband signal of the RIM-RS, through the precoding, the IFFT, and the CP insertion.

According to an embodiment, the control information 1012 including modulation scheme and a channel type index may be removed from the compressed bit data 1030, in order to further reduce a required bandwidth between DU-RU. If the control information 1012 is removed from the compressed bit data 1030, the configuration information 1035 may include the control information 1012 of the RIM-RS. In this case, a length of the compressed bit data may be reduced. For example, if the control information 1012 is included in the configuration information 1035 and excluded from the compressed bit data 1030, a length of the compressed bit data 1030 may be reduced from 10-bit to 2-bit.

The RU according to various embodiments of the present disclosure may generate a RIM-RS baseband signal by additionally performing cyclic shift and phase difference compensation, in addition to the existing functions. The RU according to various embodiments may reduce RIM-RS bits on a fronthaul interface, based on complex mapping, cyclic shift, and phase difference compensation performed in the RU, not the DU. Accordingly, a required bandwidth between the DU and the RU may be reduced.

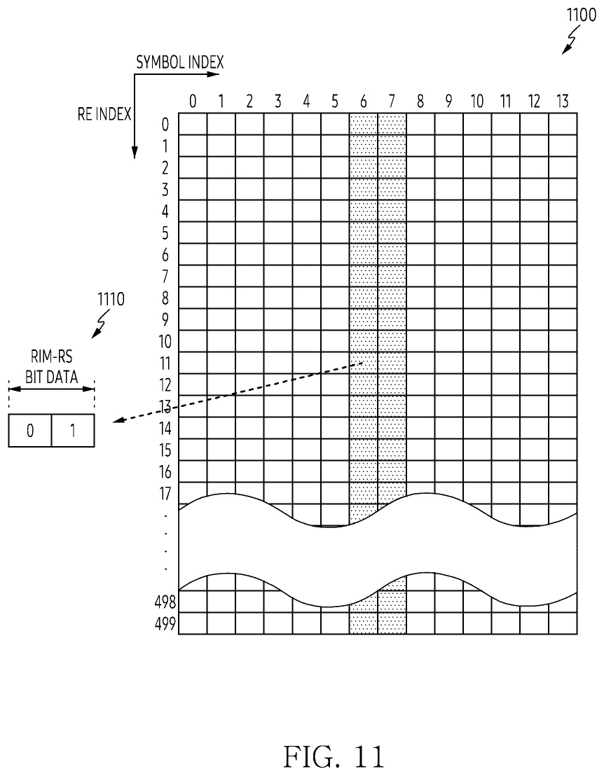

FIG. 11 is a diagram illustrating an example of RIM-RS mapping according to various embodiments. The RIM-RS may be transmitted on a RIM-RS resource, which may refer to a triplet of indexes in the time domain, frequency domain, and sequence domain. A complex-valued symbol of the RIM-RS may be generated based on QPSK modulation of a pseudo-random sequence generated based on a length 2³¹-1 gold sequence. Based on the triplet, not only a part of the QPSK-modulated gold sequence of length 2³¹-1 to be used for the RIM-RS but also the actual position in time and frequency may be calculated. Hereinafter, a time-frequency resource is described on a resource grid in FIG. 11.

Referring to FIG. 11, a resource grid 1100 may include a plurality of frequency-time resources. The frequency-time resources correspond to REs. A horizontal axis of the resource grid 1100 indicates symbols in ascending order of index. A vertical axis of the resource grid 1100 indicates REs in ascending order of index. According to the standard, up to four RIM-RS resources may be configured in a frequency domain (depending on the carrier bandwidth). A RIM-RS with 15 kHz subcarrier spacing (SCS) may occupy the entire carrier bandwidth or 96 RBs. The frequency resource of a RIM-RS with 30 kHz SCS may be limited to 48 or 96 RBs.

The DU 310 may map compressed bit data generated through bit compression to RE based on resource allocation information of the RIM-RS. One modulation symbol may be mapped to one RE. RIM-RS may be generated based on QPSK modulation from a pseudo-random sequence. Therefore, one QPSK modulation symbol may include two bits 1110. For example, two bits 1110 may be mapped to one RE. However, since the DU according to various embodiments performs resource mapping before modulation, the DU may align bits of the RIM-RS in units of two bits 1110. The aligned unit corresponds to one symbol.

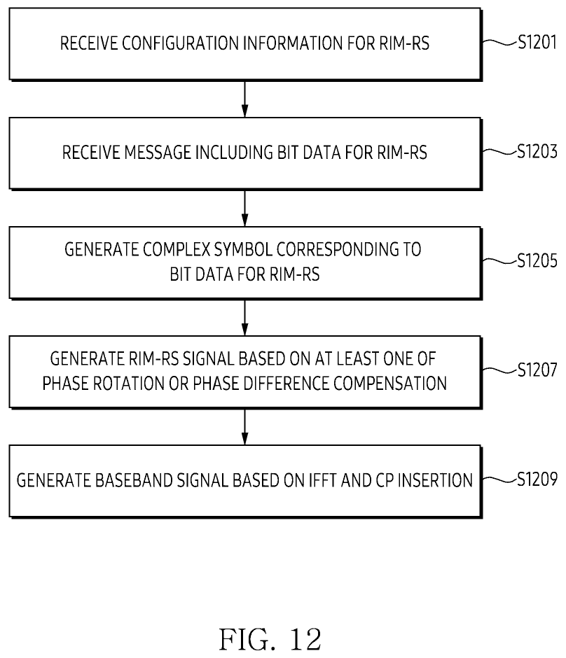

FIG. 12 is a flowchart illustrating example operations of an RU for RIM-RS transmission according to various embodiments. The RU illustrates the RU 320 of FIG. 3A. According to an embodiment, the RU 320 may include an O-RU 353-1.

Referring to FIG. 12, in operation S1201, the RU 320 may receive configuration information for RIM-RS. The configuration information may be applied in the same or similar manner as the description of the configuration information 1035 of FIG. 10. According to an embodiment, the configuration information may include channel gain information. The channel gain information may be used for complex mapping in the RU 320. In addition, according to an embodiment, the configuration information may include an indicator for indicating whether a symbol corresponding to compressed bit data 1030 is a first symbol or a second symbol among two symbols of the RIM-RS. The indicator may be used for phase rotation and phase difference compensation in the RU 320. In addition, according to an embodiment, the configuration information may include resource allocation information. The resource allocation information may be used for the phase rotation and the phase difference compensation in the RU 320. In addition, according to an embodiment, the configuration information may include cyclic shift information. The cyclic shift information may be used for the phase rotation in the RU 320. In addition, according to an embodiment, the configuration information may include phase difference information. The phase difference information may be used for the phase difference compensation in the RU 320. In addition, according to an embodiment, the configuration information may include precoding information. It may be used for application of a precoding matrix in the RU 320.

In operation S1203, the RU 320 may receive a message including bit data for the RIM-RS. According to an embodiment, the bit data for the RIM-RS may include bits of the RIM-RS. According to an embodiment, the bit data for the RIM-RS may include the bits of the RIM-RS and control information for the RIM-RS. The control information may indicate a channel type and a modulation scheme of transmitted data. The control information may include information for indicating that the bits are the RIM-RS. The control information may include information for indicating that the modulation scheme of the bits is QPSK. Meanwhile, according to an embodiment, the control information may be included in the configuration information of the operation S1201, instead of the bit data.

In operation S1205, the RU 320 may generate a complex-valued symbol corresponding to bit data for the RIM-RS. The RU 320 may obtain two bits of the RIM-RS from the bit data. The two bits of the RIM-RS may be used for QPSK modulation. The RU 320 may generate an RS sequence by performing the QPSK modulation based on the two bits. The RU 320 may apply a channel gain to the generated RS sequence. Herein, the channel gain may be obtained from the configuration information in the operation S1201. The RU 320 may generate the complex-valued symbol by applying the channel gain to the generated RF sequence. For example, the RU 320 may generate the complex-valued symbol by multiplying an amplitude scaling factor, in order to control RIM-RS transmission power.

In operation S1207, the RU 320 may generate an RIM-RS signal based on at least one of the phase rotation and the phase difference compensation. The RU 320 may perform the phase rotation. The phase rotation may refer, for example, to a cyclic shift in a time domain. As mentioned in FIG. 7, the RU 320 may perform the phase rotation in a frequency domain, in order to generate a baseband signal of the RIM-RS through a single CP inserter of the RU. RIM-RS ransmission may include two RIM-RS symbols (e.g., in total length (Nᵤ^{RIM}+N_{CP}^{RIM})T_{c} of 3GPP TS 38.211 5.3.3, corresponding to Nᵤ^{RIM}=(2·2048κ·2^{-μ})T_{c}, κ·T_{c}=Tₛ, Tₛ=1/(Δf_{ref}·N_{f,ref}), Δf_{ref}=15·10³ Hz and N_{f,ref}=2048). The phase rotation may be applied to a first RIM-RS symbol among the two RIM-RS symbols. However, the phase rotation may not be applied to a second RIM-RS symbol among the two RIM-RS symbols.

The RU 320 may perform the phase rotation based on the configuration information. According to an embodiment, the configuration information may indicate whether the symbol of a current bit data is the first RIM-RS symbol among the two RIM-RS symbols. The configuration information may indicate whether a symbol of the current bit data is the second RIM-RS symbol among the two RIM-RS symbols. The RU 320 may perform the phase rotation based on identifying that the symbol of the current bit data is the first RIM-RS symbol.

The phase rotation may be performed as many as a CP length of the second symbol among the two RIM-RS symbols of the RIM-RS transmission. The configuration information may include information for indicating the CP length of the second symbol. For example, the configuration information may include an index for indicating the CP length of the second symbol. Also, for example, the configuration information may indicate a symbol index (a symbol index within a subframe). According to a 3GPP standard, the CP length varies according to the symbol index. The CP length according to the symbol index is as follows.

$${N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = {7.2}^{μ} \\ 144 κ \cdot {2}^{- μ} & normal cyclic prefix , l \neq 0 and l \neq {7.2}^{μ}\end{matrix} \qquad [ Equation 3 ]$$

N_{CP·l}^{μ} indicates a CP length at a symbol index 1 when numerology μ. Since the RIM-RS is transmitted on an SCS of 15 kHz or 30 kHz, one of the lengths according to a normal cyclic prefix (a second row and a third row of the equation) may be used for the phase rotation.

The RU 320 may perform the phase difference compensation. Modulation and upconversion of a general NR channel (e.g., PDSCH) are performed based on a carrier frequency f0. On the other hand, modulation and upconversion of the RIM-RS are performed based on a reference point (f0RIM) configured for the RIM-RS. If the RIM-RS signal is transmitted through the same processing chain as the general NR channel implemented within the RU, it is required to compensate for a difference between the reference point (f0RIM) and the carrier frequency (f0).

Since the modulation and the upconversion of the RIM-RS are performed in a unit of an OFDM symbol, the RU 320 may identify phase difference information corresponding to the complex-valued symbol. If the complex-valued symbol is the first RIM-RS symbol among the two RIM-RS symbols, the RU 320 may identify first phase difference information corresponding to the first RIM-RS symbol. The RU 320 may perform the phase difference compensation on the phase-rotated complex-valued symbol, based on the first phase difference information. If the complex-valued symbol is the second RIM-RS symbol among the two RIM-RS symbols, the RU 320 may identify second phase difference information corresponding to the second RIM-RS symbol. The RU 320 may perform the phase difference compensation on the complex-valued symbol, based on the second phase difference information.

The RU 320 may perform the phase difference compensation based on the configuration information. The configuration information may identify second phase difference information corresponding to the first RIM-RS symbol. The configuration information may identify second phase difference information corresponding to the second RIM-RS symbol. According to an embodiment, configuration information 1035 may include information for the reference point of the RIM-RS. An RU may calculate a phase difference of a corresponding symbol based on a difference between a reference point of the RIM-RS and a carrier frequency of another NR channel. The reference point may be set to be the same or different for each symbol.

In an operation S1209, the RU 320 may generate a baseband signal based on IFFT and CP insertion. The RU 320 may apply the IFFT to the RIM-RS signal. The RU 320 may perform the CP insertion after applying the IFFT. According to an embodiment, a processing chain for the IFFT and the CP insertion may be used not only for the RIM-RS signal but also for generating an OFDM baseband signal of the general NR channel (e.g., PDSCH). Since the phase rotation and the phase difference compensation of the operation S1207 have been performed, the RU 320 may generate the baseband signal corresponding to the RIM-RS signal through an IFFT operator and a CP inserter for the general NR channel.

Although not illustrated in FIG. 12, according to an embodiment, precoding may be performed before the IFFT. A precoding matrix may be multiplied to the RIM-RS signal. In this case, the precoding matrix may be obtained from the configuration information of the operation S1201.

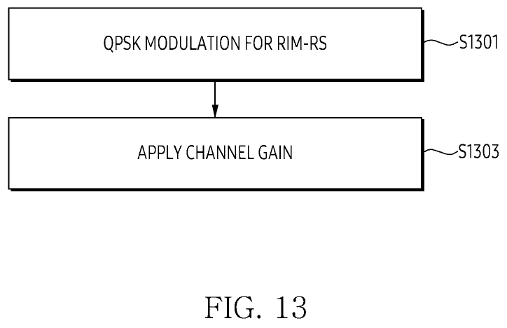

FIG. 13 is a flowchart illustrating example operations of an RU for complex mapping of RIM-RS according to various embodiments. The RU illustrates an RU 320 of FIG. 3A. According to an embodiment, the RU 320 may include an O-RU 353-1 . Operations of FIG. 13 may correspond to the complex-valued symbol generation operation of the operation 1205 of FIG. 12.

Referring to FIG. 13, in operation 51301, the RU 320 may perform QPSK modulation for the RIM-RS. The RU 320 may perform the QPSK modulation to map bits of the RIM-RS to a QPSK symbol based on control information. The RU 320 may obtain the control information. The control information may indicate a channel type of bit data. Additionally, the control information may indicate a modulation scheme of the bit data. According to an embodiment, the control information may be included in the bit data. According to an embodiment, the control information may be included in configuration information. The RU 320 may obtain an RS sequence by performing the QPSK modulation.

In operation S1303, the RU 320 may apply a channel gain. The RU 320 may apply the channel gain to the RS sequence corresponding to a result of the QPSK modulation. For example, the RU 320 may obtain a parameter according to the channel gain in order to control transmission power of RIM-RS transmission. The parameter may include an amplitude scaling factor. The RU 320 may obtain a channel gain value of the RIM-RS based on the configuration information.

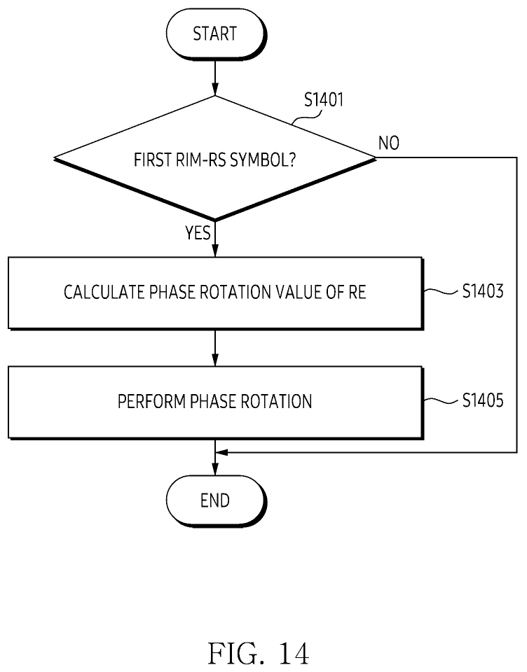

FIG. 14 is a flowchart illustrating example operations of an RU for phase rotation of RIM-RS according to various embodiments. The RU illustrates the RU 320 of FIG. 3A. According to an embodiment, the RU 320 may include an O-RU 353-1. The operations of FIG. 14 may correspond to the phase rotation operation of the operation 1207 of FIG. 12.

Referring to FIG. 14, in operation S1401, the RU 320 may identify whether a symbol of bit data is a first RIM-RS symbol. RIM-RS transmission may be performed in a unit of two OFDM symbols. The RIM-RS transmission may include two RIM-RS symbols except for a RIM-RS CP. The RU 320 may identify whether the symbol of the bit data is the first symbol among the two RIM-RS symbols. In case that the symbol of the bit data is the first RIM-RS symbol, the RU 320 may perform an operation S1403. Whether the symbol of the bit data is the first symbol among the two RIM-RS symbols may be identified based on the configuration information of the operation S1201 of FIG. 12.

In operation S1403, the RU 320 may calculate a phase rotation value of an RE. The RU 320 may identify the RE for the RIM-RS transmission. The RU 320 may calculate the phase rotation value corresponding to the RE. Rotation of a phase in a frequency domain indicates a cyclic shift in a time domain. The RU 320 may calculate a phase rotation value (e.g., a complex number value x(k) 903) for a RIM-RS signal allocated to a k-th RE. According to an embodiment, the RU 320 may calculate a phase rotation value corresponding to a CP length of a second symbol among the two RIM-RS symbols for the RIM-RS transmission. Here, the CP length of the second symbol may be identified based on the configuration information of the operation S1201 of FIG. 12.

In operation S1405, the RU 320 may perform phase rotation. The phase rotation may refer, for example, to the phase in the frequency domain being rotated. The RU 320 may perform phase rotation on a complex-valued symbol of the k-th RE of the first RIM-RS symbol, among modulated symbols.

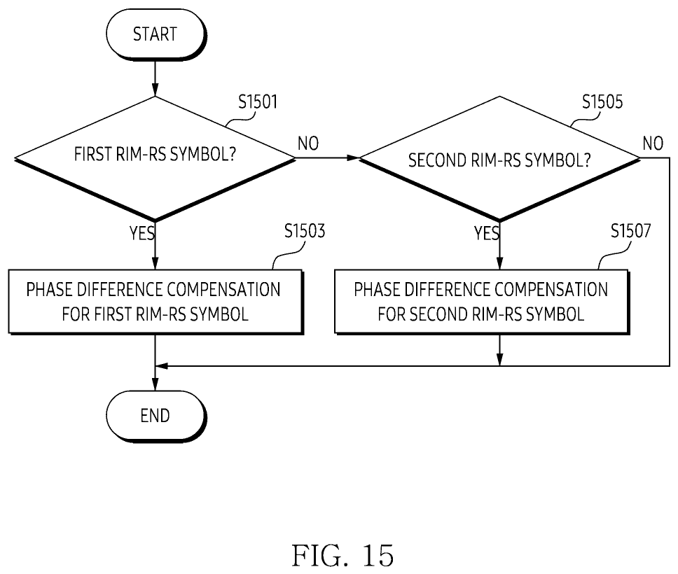

FIG. 15 is a flowchart illustrating example operations of an RU for phase difference compensation of RIM-RS according to various embodiments. The RU illustrates the RU 320 of FIG. 3A. According to an embodiment, the RU 320 may include an O-RU 353-1.

Referring to FIG. 15, in operation S1501, the RU 320 may identify whether a symbol of bit data is a first RIM-RS symbol. The first RIM-RS symbol may be a complex-valued symbol on which the phase rotation according to FIG. 14 is performed. The RU 320 may identify whether the symbol of the bit data is the first RIM-RS symbol based on configuration information. The configuration information may indicate whether the symbol of the bit data is the first RIM-RS symbol. The configuration information may indicate whether the symbol of the bit data is a second RIM-RS symbol. The configuration information may indicate whether the symbol of the bit data is the first RIM-RS symbol or the second RIM-RS symbol.

In case that the symbol of the bit data is the first RIM-RS symbol, the RU 320 may perform operation S1503. In case that the symbol of the bit data is not the first RIM-RS symbol, the RU 320 may perform operation S1505.

In operation S1503, the RU 320 may perform phase difference compensation for the first RIM-RS symbol. The RU 320 may identify a first phase difference value for the first RIM-RS symbol. Phase difference information of the configuration information may indicate the first phase difference value for the first RIM-RS symbol. A phase difference compensator of the RU 320 may utilize a modulation chain of a general NR channel. The RU 320 may compensate for a phase difference of a carrier generated in a process of generating the RIM-RS. The RU 320 may compensate for a phase difference θₗ₀ value for the first RIM-RS symbol.

In operation S1505, the RU 320 may identify whether the symbol of the bit data is the second RIM-RS symbol. The RU 320 may identify whether the symbol of bit data is the second RIM-RS symbol based on the configuration information. The configuration information may indicate whether the symbol of the bit data is the first RIM-RS symbol. The configuration information may indicate whether the symbol of the bit data is the second RIM-RS symbol. The configuration information may indicate whether the symbol of the bit data is the first RIM-RS symbol or the second RIM-RS symbol.

In case that the symbol of the bit data is the second RIM-RS symbol, the RU 320 may perform operation S1507. When the symbol of the bit data is not the second RIM-RS symbol, the RU 320 may terminate an operation.

In operation S1507, the RU 320 may perform phase difference compensation for the second RIM-RS. The RU 320 may identify a second phase difference value for the second RIM-RS symbol. The phase difference information of the configuration information may indicate the second phase difference value for the second RIM-RS symbol. The RU 320 may compensate for a θₗ₁ value for the second RIM-RS symbol.

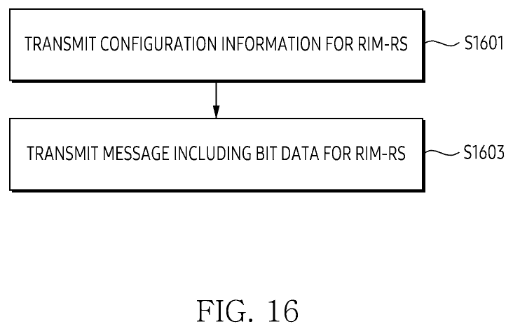

FIG. 16 is a flowchart illustrating example operations of a DU for RIM-RS transmission according to embodiments. The DU illustrates the DU 310 of FIG. 3A. According to an embodiment, an RU 320 may include an O-DU 351.

Referring to FIG. 16, in operation S1601, the DU 310 may transmit configuration information on RIM-RS. The DU 310 may transmit the configuration information on the RIM-RS to the RU 320. The configuration information may be applied in the same or similar scheme to the description of the configuration information on the configuration information 1035 of FIG. 10 or the configuration information of operation S1201 of FIG. 12. According to an embodiment, the configuration information may be transmitted based on a C-plane message or an M-plane message of an O-RAN standard. According to an embodiment, the configuration information on the RIM-RS may be included in a message defined regardless of the O-RAN standard. The DU 310 may transmit the message to the RU 320.

In operation S1603, the DU 310 may transmit a message including bit data on the RIM-RS. The DU 310 may transmit the message including the bit data on the RIM-RS to the RU 320. According to an embodiment, the bit data on the RIM-RS may include bits of the RIM-RS. According to an embodiment, the bit data on the RIM-RS may include the bits of the RIM-RS and control information for the RIM-RS. The control information may indicate a channel type and a modulation scheme of transmitted data. The control information may include information for indicating that the bits are the RIM-RS. The control information may include information for indicating that the modulation scheme of the bits is QPSK. Meanwhile, according to an embodiment, the control information may be included in the configuration information of the operation S1201, instead of the bit data.

According to an embodiment, the bit data on the RIM-RS may be included in a U-plane message of the O-RAN standard. The DU 310 may transmit the U-plane message to the RU 320. According to an embodiment, the bit data on the RIM-RS may be included in a message defined regardless of the O-RAN standard. The DU 310 may transmit the message to the RU 320.

In various embodiments of the present disclosure, a device and a method for reducing an interface requirement bandwidth between DU-RU have been provided by applying a RU modulation lossless compression technique to the RIM-RS. The device and the method according to various embodiments of the present disclosure enable transmission of a RIM-RS signal in an existing commercialized RU modulation lossless compression function split 5G system. The RU modulation lossless compression technique may refer, for example, to a technique in which a function such as complex mapping, IQ signal generation, and the like, excluding bit alignment, among functions of modulation, are performed in an RU for lossless compression.

An effect of reducing a requirement bandwidth when the RU modulation lossless compression technique is applied to the RIM-RS may be calculated differently according to embodiments. For example, as described in FIG. 6, a DU may compress the bit data 610b and the control information 612 of the RIM-RS into 10-bit and then transmit to the RU. Since complex mapping is performed in the RU, the RU may generate a 16-bit complex-valued symbol, that is, a complex-valued symbol of the RIM-RS having 16-bit of a real part and 16-bit of an imaginary part. The requirement bandwidth between the DU and the RU is reduced to 31.25% (=10/32) compared to uncompressed. As another example, when only 2-bit bit data of the RIM-RS is transmitted to the RU without control information as in FIG. 11, the bandwidth between the DU and the RU may be reduced to a maximum of 6.25% (=2/32) compared to uncompressed. Since configuration information transmitted from the DU to the RU transmitted once for a first time when setting or may be updated as needed, it may be excluded from the bandwidth reduction rate calculation. For example, through complex mapping, phase rotation, and phase difference compensation in RU according to embodiments, it is possible to operate a low requirement bandwidth between DU-RU. Unlike performing cyclic shift and phase difference compensation of a frequency domain in the DU for RIM-RS transmission the DU and the RU according to various embodiments perform cyclic shift and phase difference compensation of a frequency domain in the RU. Through this, bit compression is possible, and the RU may transmit the RIM-RS by utilizing a modulation chain of IFFT and CP insertion for a general NR channel.

According to various example embodiments, a method performed by a radio unit (RU) may comprise: receiving, from a distributed unit (DU), configuration information for remote interference management (RIM)—reference signal (RS); receiving, from the DU, a message including bit data for the RIM-RS; generating a complex-valued symbol corresponding to the bit data for the RIM-RS; generating a RIM-RS signal by performing at least one of a phase rotation or a phase difference compensation for the complex-valued symbol based on the configuration information; and generating a baseband signal corresponding to the RIM-RS signal based on an inverse fast fourier transform (IFFT) and cyclic prefix (CP) insertion of the RU.

According to an example embodiment, generating of the complex-valued symbol may comprise obtaining two bits of the bit data for the RIM-RS. Generating of the complex-valued symbol may comprise performing a quadrature phase shift keying (QPSK) modulation to the two bits.

According to an example embodiment, generating of the complex-valued symbol may comprise obtaining a RS sequence based on the QPSK. Generating of the complex-valued symbol may comprise generating the complex-valued symbol by applying channel gain to the RS sequence. Information on the channel gain may be obtained by the configuration information.

According to an example embodiment, generating of the RIM-RS signal may comprise identifying whether the bit data corresponds to a first RIM-RS symbol among two symbols for the RIM-RS. Generating of the RIM-RS signal may comprise, based on the bit data corresponding to the first RIM-RS symbol, performing a phase rotation for the complex-valued symbol. Generating of the RIM-RS signal may comprise performing a first phase difference compensation to apply a first compensation value corresponding to the first RIM-RS symbol to the phase-rotated complex-valued symbol.

According to an example embodiment, generating of the RIM-RS signal may comprise identifying whether the bit data corresponds to a second RIM-RS symbol among the two symbols for the RIM-RS. Generating of the RIM-RS signal may comprise, based on the bit data corresponding to the second RIM-RS symbol, performing a second phase difference compensation to apply a second compensation value corresponding to the second RIM-RS symbol to the complex-valued symbol.

According to an example embodiment, the first compensation value may be determined based on a difference between a reference point configured for the RIM-RS in the first RIM-RS symbol and a carrier frequency of a NR channel different from the RIM-RS. The second compensation value may be determined based on a difference between a reference point configured for the RIM-RS in the second RIM-RS symbol and the carrier frequency of the NR channel different from the RIM-RS.

According to an example embodiment, the complex-valued symbol may be a first RIM-RS symbol among the two symbols for the RIM-RS. The phase rotation for the complex-valued symbol may be performed based on a CP length for a second RIM-RS symbol among two symbols for the RIM-RS. The CP length for the second RIM-RS symbol may be determined based on an index of the second RIM-RS symbol within a slot.

According to an example embodiment, generating the baseband signal may comprise identifying a CP length for the first RIM-RS symbol. Generating the baseband signal may comprise performing the CP insertion as many as the CP length for the first RIM-RS symbol based on a CP inserter for physical downlink shared channel (PDSCH), physical downlink control channel (PDCCH), physical uplink shared channel (PUSCH), or physical uplink control channel (PUCCH). Generating the baseband signal may comprise performing the CP insertion as many as a CP length for the second RIM-RS symbol based on the CP inserter.

According to an example embodiment, the configuration information may include at least one of an indicator indicating whether a symbol corresponding to the bit data is a first symbol or a second symbol among two symbols of the RIM-RS, resource allocation information indicating time resources and frequency resources through which the RIM-RS is transmitted, information for indicating a length of a CP of the second RIM-RS symbol among the two symbols of the RIM-RS, or compensation information for performing a phase difference compensation in each symbol of the RIM-RS.

According to an example embodiment, the bit data for the RIM-RS may include bits of the RIM-RS and control information. The control information may include information for indicating that a modulation scheme related to the bits is quadrature phase shift keying (QPSK) and information for indicating that a type of the bits corresponds to the RIM-RS.

According to various example embodiments, an electronic device of a radio unit (RU) may comprise: a fronthaul transceiver, at least one radio frequency (RF) transceiver, and at least one processor, comprising processing circuitry, coupled to the fronthaul transceiver and the at least one RF transceiver, wherein at least one processor, individually and/or collectively, may be configured to: receive, from a distributed unit (DU) through the fronthaul transceiver, configuration information for remote interference management (RIM)—reference signal (RS); receive, from the DU through the fronthaul transceiver, a message including bit data for the RIM-RS; generate a complex-valued symbol corresponding to the bit data for the RIM-RS; generate a RIM-RS signal by performing at least one of a phase rotation or a phase difference compensation for the complex-valued symbol based on the configuration information; and generate a baseband signal corresponding to the RIM-RS signal based on an inverse fast fourier transform (IFFT) and cyclic prefix (CP) insertion of the RU.

According to an example embodiment, for generating of the complex-valued symbol, at least one processor, individually and/or collectively, may be configured to obtain two bits of the bit data for the RIM-RS. For generating of the complex-valued symbol, at least one processor, individually and/or collectively, may be configured to perform a quadrature phase shift keying (QPSK) modulation to the two bits.

According to an example embodiment, for generating of the complex-valued symbol, at least one processor, individually and/or collectively, may be configured to obtain a RS sequence based on the QPSK. For generating of the complex-valued symbol, at least one processor, individually and/or collectively, may be configured to generate the complex-valued symbol by applying channel gain to the RS sequence. Information on the channel gain may be obtained by the configuration information.

According to an example embodiment, for generating of the RIM-RS signal, at least one processor, individually and/or collectively, may be configured to identify whether the bit data corresponds to a first RIM-RS symbol among two symbols for the RIM-RS. For generating of the RIM-RS signal, at least one processor, individually and/or collectively, may be configured to, based on the bit data corresponding to the first RIM-RS symbol, perform a phase rotation for the complex-valued symbol. For generating of the RIM-RS signal, at least one processor, individually and/or collectively, may be configured to perform a first phase difference compensation to apply a first compensation value corresponding to the first RIM-RS symbol to the phase-rotated complex-valued symbol.

According to an example embodiment, for generating of the RIM-RS signal, at least one processor, individually and/or collectively, may be configured to identify whether the bit data corresponds to a second RIM-RS symbol among the two symbols for the RIM-RS. For generating of the RIM-RS signal, at least one processor, individually and/or collectively, may be configured to, based on the bit data corresponding to the second RIM-RS symbol, perform a second phase difference compensation to apply a second compensation value corresponding to the second RIM-RS symbol to the complex-valued symbol.

According to an example embodiment, the first compensation value may be determined based on a difference between a reference point configured for the RIM-RS in the first RIM-RS symbol and a carrier frequency of a NR channel different from the RIM-RS. The second compensation value may be determined based on a difference between a reference point configured for the RIM-RS in the second RIM-RS symbol and the carrier frequency of the NR channel different from the RIM-RS.

According to an example embodiment, the complex-valued symbol may be a first RIM-RS symbol among the two symbols for the RIM-RS. The phase rotation for the complex-valued symbol may be performed based on a CP length for a second RIM-RS symbol among two symbols for the RIM-RS. The CP length for the second RIM-RS symbol may be determined based on an index of the second RIM-RS symbol within a slot.

According to an example embodiment, for generating the baseband signal, at least one processor, individually and/or collectively, may be configured to identify a CP length for the first RIM-RS symbol. For generating the baseband signal, at least one processor, individually and/or collectively, may be configured to perform the CP insertion as many as the CP length for the first RIM-RS symbol based on a CP inserter for physical downlink shared channel (PDSCH), physical downlink control channel (PDCCH), physical uplink shared channel (PUSCH), or physical uplink control channel (PUCCH). For generating the baseband signal, at least one processor, individually and/or collectively, may be configured to perform the CP insertion as many as a CP length for the second RIM-RS symbol based on the CP inserter.

According to an example embodiment, the configuration information may include at least one of an indicator for indicating whether a symbol corresponding to the bit data is a first symbol or a second symbol among two symbols of the RIM-RS, resource allocation information indicating time resources and frequency resources through which the RIM-RS is transmitted, information indicating a length of a CP of the second RIM-RS symbol among the two symbols of the RIM-RS, or compensation information for performing a phase difference compensation in each symbol of the RIM-RS.

According to an example embodiment, the bit data for the RIM-RS may include bits of the RIM-RS and control information. The control information may include information indicating that a modulation scheme related to the bits is quadrature phase shift keying (QPSK) and information indicating that a type of the bits corresponds to the RIM-RS.

According to various example embodiments, a method performed by a distributed unit (DU) may comprise: transmitting, to a radio unit (RU), configuration information for remote interference management (RIM)—reference signal (RS); transmitting, to the RU, a message including bit data for the RIM-RS, wherein the configuration information may be used for at least one of a phase rotation or a phase difference compensation for a complex-valued symbol to generate a baseband signal through inverse fast fourier transform (IFFT) and cyclic prefix (CP) insertion of the RU, and the complex-valued symbol may correspond to a modulation result of the bit data for the RIM-RS.

According to various example embodiments, an electronic device of a distributed unit (DU) may comprise: at least one transceiver including a fronthaul transceiver, and at least one processor, comprising processing circuitry, coupled to the at least one transceiver, wherein at least one processor, individually and/or collectively, may be configured to: transmit, to a radio unit (RU) through the fronthaul transceiver, configuration information for remote interference management (RIM)—reference signal (RS); transmit, to the RU through the fronthaul transceiver, a message including bit data for the RIM-RS, wherein the configuration information may be used for at least one of a phase rotation or a phase difference compensation for a complex-valued symbol to generate a baseband signal through inverse fast fourier transform (IFFT) and cyclic prefix (CP) insertion of the RU, and the complex-valued symbol may correspond to a modulation result of the bit data for the RIM-RS.

According to various example embodiments, a non-transitory computer-readable storage medium is provided. The non-transitory computer-readable storage medium may store one or more programs. The one or more programs may comprise instructions which, when executed by at least one processor, comprising processing circuitry of a radio unit (RU), individually and/or collectively, cause the RU to: receive, from a distributed unit (DU), configuration information for remote interference management (RIM)—reference signal (RS); receive, from the DU, a message including bit data for the RIM-RS; generate a complex-valued symbol corresponding to the bit data for the RIM-RS; generate a RIM-RS signal by performing at least one of a phase rotation or a phase difference compensation for the complex-valued symbol based on the configuration information; and generate a baseband signal corresponding to the RIM-RS signal based on an inverse fast fourier transform (IFFT) and cyclic prefix (CP) insertion of the RU.

According to various example embodiments, a non-transitory computer-readable storage medium is provided. The non-transitory computer-readable storage medium may store one or more programs. The one or more programs may comprise instructions which, when executed by at least one processor, comprising processing circuitry, of a distributed unit (DU), individually and/or collectively, cause the DU to: transmit, to a radio unit (RU), configuration information for remote interference management (RIM)—reference signal (RS); transmit, to the RU, a message including bit data for the RIM-RS, wherein the configuration information may be used for at least one of a phase rotation or a phase difference compensation for a complex-valued symbol to generate a baseband signal through inverse fast fourier transform (IFFT) and cyclic prefix (CP) insertion of the RU, and the complex-valued symbol may correspond to a modulation result of the bit data for the RIM-RS.

Methods according to various example embodiments may be implemented as a form of hardware, software, or a combination of hardware and software.

In case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to various embodiments.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. It may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the present disclosure through an external port. In addition, a separate storage device on the communication network may also be connected to a device performing an embodiment of the present disclosure.

In the above-described various embodiments of the present disclosure, components included in the disclosure are expressed in the singular or plural according to the presented specific embodiment. However, the singular or plural expression is selected appropriately according to a situation presented for convenience of explanation, and the present disclosure is not limited to the singular or plural component, and even components expressed in the plural may be configured in the singular, or a component expressed in the singular may be configured in the plural.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method performed by a radio unit (RU), the method comprising:
receiving, from a distributed unit (DU), configuration information for remote interference management (RIM)—reference signal (RS);
receiving, from the DU, a message including bit data for the RIM-RS;
generating a complex-valued symbol corresponding to the bit data for the RIM-RS;
generating a RIM-RS signal by performing at least one of a phase rotation or a phase difference compensation for the complex-valued symbol based on the configuration information; and
generating a baseband signal corresponding to the RIM-RS signal based on an inverse fast fourier transform (IFFT) and cyclic prefix (CP) insertion of the RU.

2. The method of claim 1, wherein generating the complex-valued symbol comprises:
obtaining two bits of the bit data for the RIM-RS; and
performing a quadrature phase shift keying (QPSK) modulation on the two bits.

3. The method of claim 2, wherein the generating of the complex-valued symbol comprises:
obtaining a RS sequence based on the QPSK; and
generating the complex-valued symbol by applying channel gain to the RS sequence, and
wherein information on the channel gain is obtained by the configuration information.

4. The method of claim 1, wherein the generating of the RIM-RS signal comprises:
identifying whether the bit data corresponds to a first RIM-RS symbol among two symbols for the RIM-RS;
based on the bit data corresponding to the first RIM-RS symbol, performing a phase rotation for the complex-valued symbol; and
performing a first phase difference compensation to apply a first compensation value corresponding to the first RIM-RS symbol to the phase-rotated complex-valued symbol.

5. The method of claim 4, wherein the generating of the RIM-RS signal comprises:
identifying whether the bit data corresponds to a second RIM-RS symbol among the two symbols for the RIM-RS; and
based on the bit data corresponding to the second RIM-RS symbol, performing a second phase difference compensation to apply a second compensation value corresponding to the second RIM-RS symbol to the complex-valued symbol.

6. The method of claim 5,
wherein the first compensation value is determined based on a difference between a reference point configured for the RIM-RS in the first RIM-RS symbol and a carrier frequency of a new radio (NR) channel different from the RIM-RS, and
wherein the second compensation value is determined based on a difference between a reference point configured for the RIM-RS in the second RIM-RS symbol and the carrier frequency of the NR channel different from the RIM-RS.

7. The method of claim 1,
wherein the complex-valued symbol is a first RIM-RS symbol among the two symbols for the RIM-RS,
wherein the phase rotation for the complex-valued symbol is performed based on a CP length for a second RIM-RS symbol among two symbols for the RIM-RS, and
wherein the CP length for the second RIM-RS symbol is determined based on an index of the second RIM-RS symbol within a slot.

8. The method of claim 7, wherein the generating the baseband signal comprises:
identifying a CP length for the first RIM-RS symbol; and
performing the CP insertion as many as the CP length for the first RIM-RS symbol based on a CP inserter for physical downlink shared channel (PDSCH), physical downlink control channel (PDCCH), physical uplink shared channel (PUSCH), or physical uplink control channel (PUCCH); and
performing the CP insertion as many as a CP length for the second RIM-RS symbol based on the CP inserter.

9. The method of claim 1,
wherein the configuration information includes at least one of:
an indicator indicating whether a symbol corresponding to the bit data is a first symbol or a second symbol among two symbols of the RIM-RS;
resource allocation information indicating time resources and frequency resources through which the RIM-RS is transmitted;
information indicating a length of a CP of the second RIM-RS symbol among the two symbols of the RIM-RS; or
compensation information for performing a phase difference compensation in each symbol of the RIM-RS.

10. The method of claim 1,
wherein the bit data for the RIM-RS includes bits of the RIM-RS and control information, and
wherein the control information includes information indicating that a modulation scheme related to the bits is quadrature phase shift keying (QPSK) and information indicating that a type of the bits corresponds to the RIM-RS.

11. An electronic device of a radio unit (RU), comprising:
a fronthaul transceiver;
at least one radio frequency (RF) transceiver;
at least one processor, comprising processing circuitry, coupled to the fronthaul transceiver and the at least one RF transceiver; and
memory storing instructions that, when executed by the at least one processor individually and/or collectively, cause the RU to:
receive, from a distributed unit (DU) through the fronthaul transceiver, configuration information for remote interference management (RIM)—reference signal (RS),
receive, from the DU through the fronthaul transceiver, a message including bit data for the RIM-RS;
generate a complex-valued symbol corresponding to the bit data for the RIM-RS;
generate a RIM-RS signal by performing at least one of a phase rotation or a phase difference compensation for the complex-valued symbol based on the configuration information; and
generate a baseband signal corresponding to the RIM-RS signal based on an inverse fast fourier transform (IFFT) and cyclic prefix (CP) insertion of the RU.

12. The electronic device of claim 11, wherein, to generate the complex-valued symbol, the instructions, when executed by the at least one processor individually and/or collectively, cause the RU to:
obtain two bits of the bit data for the RIM-RS; and
perform a quadrature phase shift keying (QPSK) modulation on the two bits.

13. The electronic device of claim 12, wherein, to generate the complex-valued symbol, the instructions, when executed by the at least one processor individually and/or collectively, cause the RU to:
obtain a RS sequence based on the QPSK; and
generate the complex-valued symbol by applying channel gain to the RS sequence, and
wherein information on the channel gain is obtained by the configuration information.

14. The electronic device of claim 11, wherein, to generate the RIM-RS signal, the instructions, when executed by the at least one processor individually and/or collectively, cause the RU to:
identify whether the bit data corresponds to a first RIM-RS symbol among two symbols for the RIM-RS;
based on the bit data corresponding to the first RIM-RS symbol, perform a phase rotation for the complex-valued symbol; and
perform a first phase difference compensation to apply a first compensation value corresponding to the first RIM-RS symbol to the phase-rotated complex-valued symbol.

15. The electronic device of claim 14, wherein, to generate the RIM-RS signal, the instructions, when executed by the at least one processor individually and/or collectively, cause the RU to:
identify whether the bit data corresponds to a second RIM-RS symbol among the two symbols for the RIM-RS; and
based on the bit data corresponding to the second RIM-RS symbol, perform a second phase difference compensation to apply a second compensation value corresponding to the second RIM-RS symbol to the complex-valued symbol.

16. The electronic device of claim 15,
wherein the first compensation value is determined based on a difference between a reference point configured for the RIM-RS in the first RIM-RS symbol and a carrier frequency of a new radio (NR) channel different from the RIM-RS, and
wherein the second compensation value is determined based on a difference between a reference point configured for the RIM-RS in the second RIM-RS symbol and the carrier frequency of the NR channel different from the RIM-RS.

17. The electronic device of claim 11,
wherein the complex-valued symbol is a first RIM-RS symbol among the two symbols for the RIM-RS,
wherein the phase rotation for the complex-valued symbol is performed based on a CP length for a second RIM-RS symbol among two symbols for the RIM-RS, and
wherein the CP length for the second RIM-RS symbol is determined based on an index of the second RIM-RS symbol within a slot.

18. The electronic device of claim 17, wherein, to generate the baseband signal, the instructions, when executed by the at least one processor individually and/or collectively, cause the RU to:
identify a CP length for the first RIM-RS symbol; and
perform the CP insertion as many as the CP length for the first RIM-RS symbol based on a CP inserter for physical downlink shared channel (PDSCH), physical downlink control channel (PDCCH), physical uplink shared channel (PUSCH), or physical uplink control channel (PUCCH); and
perform the CP insertion as many as a CP length for the second RIM-RS symbol based on the CP inserter.

19. The electronic device of claim 11,
wherein the configuration information includes at least one of:
an indicator indicating whether a symbol corresponding to the bit data is a first symbol or a second symbol among two symbols of the RIM-RS;
resource allocation information indicating time resources and frequency resources through which the RIM-RS is transmitted;
information indicating a length of a CP of the second RIM-RS symbol among the two symbols of the RIM-RS; or
compensation information for performing a phase difference compensation in each symbol of the RIM-RS.

20. A non-transitory computer-readable storage medium comprising memory storing one or more programs,
wherein the one or more programs are configured, when executed by at least one processor, comprising processing circuitry, to cause a radio unit (RU) to perform the method according to claim 1.
